(19) United States
(12) Patent Application Publication
(10) Pub. No.: US 2025/0318009 A1
(43) Pub. Date: Oct. 9, 2025

(54) NETWORK ENERGY SAVINGS TECHNIQUES IN THE PRESENCE OF CAMPED USER EQUIPMENT

(71) Applicant: QUALCOMM Incorporated, San Diego, CA (US)

(72) Inventors: Navid ABEDINI, Basking Ridge, NJ (US); Kapil GULATI, Belle Mead, NJ (US); Naeem AKL, Bridgewater, NJ (US)

(21) Appl. No.: 18/629,526

(22) Filed: Apr. 8, 2024

(51) Int. Cl. H04W 76/28; H04W 52/02; H04W 64/00; H04W 68/02; H04W 72/232

(52) U.S. Cl. CPC H04W 76/28; H04W 52/0235; H04W 64/00; H04W 68/02; H04W 72/232

(57) ABSTRACT

Methods, systems, and devices for wireless communications are described. A user equipment (UE) may receive a message from a network entity in accordance with an active duration of a discontinuous reception (DRX) operation at the UE. The message may include a request for information indicative of a location of the UE within a cell associated with the network entity. The UE may transmit, within the active duration, a response message to the network entity that indicates the information associated with the location of the UE within the cell. Accordingly, the network entity may adjust one or more communication parameters associated with the cell based on receiving the response message from the UE. The UE may monitor for one or more additional messages from the network entity in accordance with the DRX operation and based on transmitting the response message.

### FIELD OF TECHNOLOGY

The following relates to wireless communications, including network energy savings techniques in the presence of camped user equipment (UEs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support network energy savings techniques in the presence of camped user equipment. For example, the described techniques enable a user equipment (UE) to receive, from a network entity, a message (e.g., a survey indication) in accordance with (e.g., during, within) an active duration of a discontinuous reception (DRX) (e.g., idle mode DRX) operation at the UE. The message may include a request for information indicative of a location of the UE within a cell associated with the network entity, other information associated with the UE, or information associated with one or more other UEs, among other examples. Based on receiving the message, the UE may transmit, within the active duration, a response message (e.g., an uplink keep-alive signal (KAS), an uplink wake-up signal (WUS)) to the network entity that indicates the request information associated with the UE (e.g., the location of the UE within the cell). Accordingly, the network entity may adjust one or more communication parameters (e.g., access signal frequency, transmission deactivation, transmission power, communication directions) associated with the cell based on receiving the response message from the UE. Further, the UE may continue to monitor for one or more additional messages from the network entity in accordance with the DRX operation (e.g., may continue camping on the cell) and based on transmitting the response message.

A method for wireless communications by a UE is described. The method may include receiving, from a network entity, a message in accordance with an active duration of a discontinuous reception operation at the UE, where the message includes a request for information indicative of a location of the UE within a cell associated with the network entity, transmitting, within the active duration, a response message to the network entity based on receiving the message, where the response message indicates the information associated with the location of the UE within the cell, and monitoring for one or more additional messages from the network entity in accordance with the discontinuous reception operation and based on transmitting the response message.

A UE for wireless communications is described. The UE may include one or more memories storing processor executable code, and one or more processors coupled with the one or more memories. The one or more processors may individually or collectively be operable to execute the code to cause the UE to receive, from a network entity, a message in accordance with an active duration of a discontinuous reception operation at the UE, where the message includes a request for information indicative of a location of the UE within a cell associated with the network entity, transmit, within the active duration, a response message to the network entity based on receiving the message, where the response message indicates the information associated with the location of the UE within the cell, and monitor for one or more additional messages from the network entity in accordance with the discontinuous reception operation and based on transmitting the response message.

Another UE for wireless communications is described. The UE may include means for receiving, from a network entity, a message in accordance with an active duration of a discontinuous reception operation at the UE, where the message includes a request for information indicative of a location of the UE within a cell associated with the network entity, means for transmitting, within the active duration, a response message to the network entity based on receiving the message, where the response message indicates the information associated with the location of the UE within the cell, and means for monitoring for one or more additional messages from the network entity in accordance with the discontinuous reception operation and based on transmitting the response message.

A non-transitory computer-readable medium storing code for wireless communications is described. The code may include instructions executable by one or more processors to receive, from a network entity, a message in accordance with an active duration of a discontinuous reception operation at the UE, where the message includes a request for information indicative of a location of the UE within a cell associated with the network entity, transmit, within the active duration, a response message to the network entity based on receiving the message, where the response message indicates the information associated with the location of the UE within the cell, and monitor for one or more additional messages from the network entity in accordance with the discontinuous reception operation and based on transmitting the response message.

In some examples of the method, UEs, and non-transitory computer-readable medium described herein, receiving the message may include operations, features, means, or instructions for receiving the message via a paging physical downlink control channel message, a paging early indication message, a wake-up signal message, or any combination thereof.

In some examples of the method, UEs, and non-transitory computer-readable medium described herein, receiving the message may include operations, features, means, or instructions for receiving the message in accordance with a directional parameter associated with the message, where the directional parameter may be configured by the network entity.

In some examples of the method, UEs, and non-transitory computer-readable medium described herein, the request for the information may be applicable to a set of UEs associated with the network entity and transmitting the response message may be based on the UE being included in the set of UEs.

In some examples of the method, UEs, and non-transitory computer-readable medium described herein, the set of UEs corresponds to a set of inactive UEs, a set of UEs associated with a same group identifier, a set of UEs associated with a same paging occasion, a set of UEs associated with a same paging frame, a set of UEs associated with a same UE type, a set of UEs associated with a same mobility state, a set of UEs associated with a same coverage region of the cell, or any combination thereof.

In some examples of the method, UEs, and non-transitory computer-readable medium described herein, transmitting the response message may include operations, features, means, or instructions for transmitting the response message via an uplink keep-alive signal message, an uplink wake-up signal message, or both.

In some examples of the method, UEs, and non-transitory computer-readable medium described herein, transmitting the response message may include operations, features, means, or instructions for transmitting the response message in accordance with a preamble identifier, a scrambling identifier, a resource configuration, or any combination thereof, where the information may be indicative of the location of the UE based on the preamble identifier, the scrambling identifier, the resource configuration, or any combination thereof.

Some examples of the method, UEs, and non-transitory computer-readable medium described herein may further include operations, features, means, or instructions for selecting the preamble identifier, the scrambling identifier, the resource configuration, or any combination thereof based on a reference signal receive power (RSRP) associated with the cell, a pathloss associated with the cell, a mobility state of the UE, a coverage region of the cell associated with the UE, a type associated with the UE, or any combination thereof, where transmitting the response message may be based on the selecting.

Some examples of the method, UEs, and non-transitory computer-readable medium described herein may further include operations, features, means, or instructions for selecting a preamble identifier to use for transmitting the response message from a set of preamble identifiers configured by the network entity, where transmitting the response message may be based on selecting the preamble identifier.

Some examples of the method, UEs, and non-transitory computer-readable medium described herein may further include operations, features, means, or instructions for receiving a capability message from the network entity that indicates whether the cell of the network entity supports communication of the message and the response message in accordance with the active duration of the DRX operation at the UE, where receiving the message may be based on receiving the capability message.

Some examples of the method, UEs, and non-transitory computer-readable medium described herein may further include operations, features, means, or instructions for receiving a configuration message from the network entity that indicates one or more message parameters associated with receiving the message and one or more response parameters associated with transmitting the response message, where receiving the message or transmitting the response message, or both, may be based on the configuration message.

Some examples of the method, UEs, and non-transitory computer-readable medium described herein may further include operations, features, means, or instructions for receiving a capability message associated with the message and the response message, a configuration message associated with the message and the response message, or both via a system information block message, a radio resource control message, a broadcast message, or any combination thereof.

Some examples of the method, UEs, and non-transitory computer-readable medium described herein may further include operations, features, means, or instructions for transmitting a second message to the network entity, the second message including second information associated with an area of the cell that may be within a distance threshold of the UE.

Some examples of the method, UEs, and non-transitory computer-readable medium described herein may further include operations, features, means, or instructions for establishing a connection with the network entity based on receiving the message and transmitting the response message, the second message, or both to the network entity based on establishing the connection.

A method for wireless communications by a network entity is described. The method may include outputting a message to a UE in accordance with an active duration of a DRX operation the UE, where the message includes a request for information indicative of a location of the UE within a cell associated with the network entity, obtaining, within the active duration, a response message from the UE based on transmitting the message, where the response message indicates the information associated with the location of the UE within the cell, and adjusting one or more communication parameters associated with the cell based on receiving the response message from the UE.

A network entity for wireless communications is described. The network entity may include one or more memories storing processor executable code, and one or more processors coupled with the one or more memories. The one or more processors may individually or collectively be operable to execute the code to cause the network entity to output a message to a UE in accordance with an active duration of a DRX operation the UE, where the message includes a request for information indicative of a location of the UE within a cell associated with the network entity, obtain, within the active duration, a response message from the UE based on transmitting the message, where the response message indicates the information associated with the location of the UE within the cell, and adjust one or more communication parameters associated with the cell based on receiving the response message from the UE.

Another network entity for wireless communications is described. The network entity may include means for outputting a message to a UE in accordance with an active duration of a DRX operation the UE, where the message includes a request for information indicative of a location of the UE within a cell associated with the network entity, means for obtaining, within the active duration, a response message from the UE based on transmitting the message, where the response message indicates the information associated with the location of the UE within the cell, and means for adjusting one or more communication parameters associated with the cell based on receiving the response message from the UE.

A non-transitory computer-readable medium storing code for wireless communications is described. The code may include instructions executable by one or more processors to output a message to a UE in accordance with an active duration of a DRX operation the UE, where the message includes a request for information indicative of a location of the UE within a cell associated with the network entity, obtain, within the active duration, a response message from the UE based on transmitting the message, where the response message indicates the information associated with the location of the UE within the cell, and adjust one or more communication parameters associated with the cell based on receiving the response message from the UE.

In some examples of the method, network entities, and non-transitory computer-readable medium described herein, adjusting the one or more communication parameters may include operations, features, means, or instructions for adjusting one or more of a quantity of discovery signals transmitted within a time duration and associated with one or more communication directions, a transmit power parameter of the network entity, a directional communication parameter, a quantity of random access channel resources associated with one or more communication directions, or any combination thereof.

In some examples of the method, network entities, and non-transitory computer-readable medium described herein, outputting the message may include operations, features, means, or instructions for outputting the message via a paging physical downlink control channel message, a paging early indication message, a wake-up signal message, or any combination thereof.

In some examples of the method, network entities, and non-transitory computer-readable medium described herein, outputting the message may include operations, features, means, or instructions for outputting the message in accordance with a directional parameter associated with the message, where the message may be output in one or more directions from the network entity based on the directional parameter.

In some examples of the method, network entities, and non-transitory computer-readable medium described herein, the request for the information may be applicable to a set of UEs associated with the network entity and obtaining the response message may be based on the UE being included in the set of UEs.

In some examples of the method, network entities, and non-transitory computer-readable medium described herein, the set of UEs corresponds to a set of inactive UEs, a set of UEs associated with a same group identifier, a set of UEs associated with a same paging occasion, a set of UEs associated with a same paging frame, a set of UEs associated with a same UE type, a set of UEs associated with a same mobility state, a set of UEs associated with a same coverage region of the cell, or any combination thereof.

In some examples of the method, network entities, and non-transitory computer-readable medium described herein, obtaining the response message may include operations, features, means, or instructions for obtaining the response message via an uplink keep-alive signal message, an uplink wake-up signal message, or both.

In some examples of the method, network entities, and non-transitory computer-readable medium described herein, obtaining the response message may include operations, features, means, or instructions for obtaining the response message in accordance with a preamble identifier, a scrambling identifier, a resource configuration, or any combination thereof, where the information may be indicative of the location of the UE based on the preamble identifier, the scrambling identifier, the resource configuration, or any combination thereof.

Some examples of the method, network entities, and non-transitory computer-readable medium described herein may further include operations, features, means, or instructions for outputting an indication of the preamble identifier, the scrambling identifier, the resource configuration, or any combination thereof based on an RSRP associated with the cell, a pathloss associated with the cell, a mobility state of the UE, a coverage region of the cell associated with the UE, a type associated with the UE, or any combination thereof, where obtaining the response message may be based on outputting the indication.

Some examples of the method, network entities, and non-transitory computer-readable medium described herein may further include operations, features, means, or instructions for configuring a set of preamble identifiers to use for obtaining one or more response messages, where obtaining the response message may be based on configuring the set of preamble identifiers.

Some examples of the method, network entities, and non-transitory computer-readable medium described herein may further include operations, features, means, or instructions for outputting a capability message to the UE that indicates whether the cell of the network entity supports communication of the message and the response message in accordance with the active duration of the DRX operation at the UE, where outputting the message may be based on outputting the capability message.

Some examples of the method, network entities, and non-transitory computer-readable medium described herein may further include operations, features, means, or instructions for outputting a configuration message to the UE that indicates one or more message parameters associated with outputting the message and one or more response parameters associated with obtaining the response message.

Some examples of the method, network entities, and non-transitory computer-readable medium described herein may further include operations, features, means, or instructions for outputting a capability message associated with the message and the response message, a configuration message associated with the message and the response message, or both via a system information block message, a radio resource control message, a broadcast message, or any combination thereof.

Some examples of the method, network entities, and non-transitory computer-readable medium described herein may further include operations, features, means, or instructions for obtaining, based on outputting the message, a second message, the second message including second information associated with an area of the cell that may be within a distance threshold of the UE.

Some examples of the method, network entities, and non-transitory computer-readable medium described herein may further include operations, features, means, or instructions for establishing a connection with the UE based on outputting the message and obtaining the response message, the second message, or both from the UE based on establishing the connection.

### BRIEF DESCRIPTION OF THE DRAWINGS

FIG. 1 shows an example of a wireless communications system that supports network energy savings techniques in the presence of camped user equipment in accordance with one or more aspects of the present disclosure.

FIG. 2 shows an example of a wireless communications system that supports network energy savings techniques in the presence of camped user equipment in accordance with one or more aspects of the present disclosure.

FIG. 3 shows an example of a process flow that supports network energy savings techniques in the presence of camped user equipment in accordance with one or more aspects of the present disclosure.

FIGS. 4 and 5 show block diagrams of devices that support network energy savings techniques in the presence of camped user equipment in accordance with one or more aspects of the present disclosure.

FIG. 6 shows a block diagram of a communications manager that supports network energy savings techniques in the presence of camped user equipment in accordance with one or more aspects of the present disclosure.

FIG. 7 shows a diagram of a system including a device that supports network energy savings techniques in the presence of camped user equipment in accordance with one or more aspects of the present disclosure.

FIGS. 8 and 9 show block diagrams of devices that support network energy savings techniques in the presence of camped user equipment in accordance with one or more aspects of the present disclosure.

FIG. 10 shows a block diagram of a communications manager that supports network energy savings techniques in the presence of camped user equipment in accordance with one or more aspects of the present disclosure.

FIG. 11 shows a diagram of a system including a device that supports network energy savings techniques in the presence of camped user equipment in accordance with one or more aspects of the present disclosure.

FIGS. 12 through 15 show flowcharts illustrating methods that support network energy savings techniques in the presence of camped user equipment in accordance with one or more aspects of the present disclosure.

### DETAILED DESCRIPTION

A user equipment (UE) associated with a cell (e.g., of a network entity) may operate in an inactive mode (e.g., a discontinuous reception (DRX) mode, an idle mode DRX (I-DRX), a connected mode DRX). The inactive mode may enable the UE to save power during durations in which the UE does not actively communicate with the network entity. Although the UE may not have an established connection with the network entity in DRX mode, the UE may remain “camped” on the cell (e.g., the UE may maintain its selection of the cell, the UE may remain associated with the cell). However, the network entity may not have information associated with the inactive UEs (e.g., locations of inactive UEs within the cell, how many inactive UEs are camped on the cell) based on the lack of an active connection. Further, the network entity may support one or more network energy saving (NES) techniques to reduce power consumption, which may impact the inactive (e.g., camped) UEs on the cell. For instance, a network entity may reduce a quantity of broadcast signals that support cell connection (e.g., a synchronization signal block (SSB), a system information block (SIB), reduce the quantity of signals transmitted per unit of time), reduce a transmit power for broadcast signaling, reduce broadcast transmissions for certain beam directions, or employ other energy saving techniques, which may cause the inactive UEs to be dropped from service coverage. That is, at least some camped UEs may fail to receive such reduced broadcast signaling, which may cause the camped UEs to repeat cell selection procedures, resulting in increased power consumption and decreased communication reliability, among other issues, in the wireless communication system.

In accordance with one or more aspects of the present disclosure, a UE, a network entity, and other wireless communication devices may support signaling techniques that enable a network entity to obtain information associated with one or more inactive UEs camped on a cell and adjust its communication parameters based on the obtained information. For example, the network entity may transmit one or more messages (e.g., one or more survey indications) to one or more UEs (e.g., idle UEs, inactive UEs, camped UEs) during an active duration of a DRX operation (e.g., I-DRX) at the one or more UEs (e.g., during an ON duration of the DRX UEs). The one or more messages may request a response message from one or more of inactive (e.g., camped) UEs that includes information associated with the inactive UEs. In some examples, the one or more messages may be transmitted from the network entity in all directions or a subset of directions and may request a response from all inactive UEs or a subset of inactive UEs.

Accordingly, the UEs may transmit one or more response messages (e.g., an uplink keep-alive signal (KAS), an uplink wake-up signal (WUS)) that includes the information requested by the network entity. Based on receiving the response messages, the network entity may obtain (e.g., acquire) information about the inactive UEs (e.g., location information, status information, a quantity of camped UEs). In some examples, the response messages may indicate the information based on a choice of signal parameters (e.g., a choice of a preamble identifier or a scrambling identifier) or based on a resource configuration used for transmitting the response messages. In some examples, the network entity may indicate whether such signaling techniques are supported by the network entity. Thus, the network entity may account for the inactive UEs (e.g., camped UEs) when determining whether to use (e.g., activate, employ, adopt) NES techniques (e.g., by adjusting its communication parameters, reduce broadcast signal transmission periodicity, reduce transmit power, adjust beam directions). As such, the network entity may be enabled to conserve energy without impacting the inactive UEs camped on the cell, thus improving energy consumption efficiency, improving communication reliability, and improving network sustainability in wireless communications systems.

Aspects of the disclosure are initially described in the context of wireless communications systems. Aspects of the disclosure are further illustrated by and described with reference to process flows, apparatus diagrams, system diagrams, and flowcharts that relate to network energy savings techniques in the presence of camped user equipment.

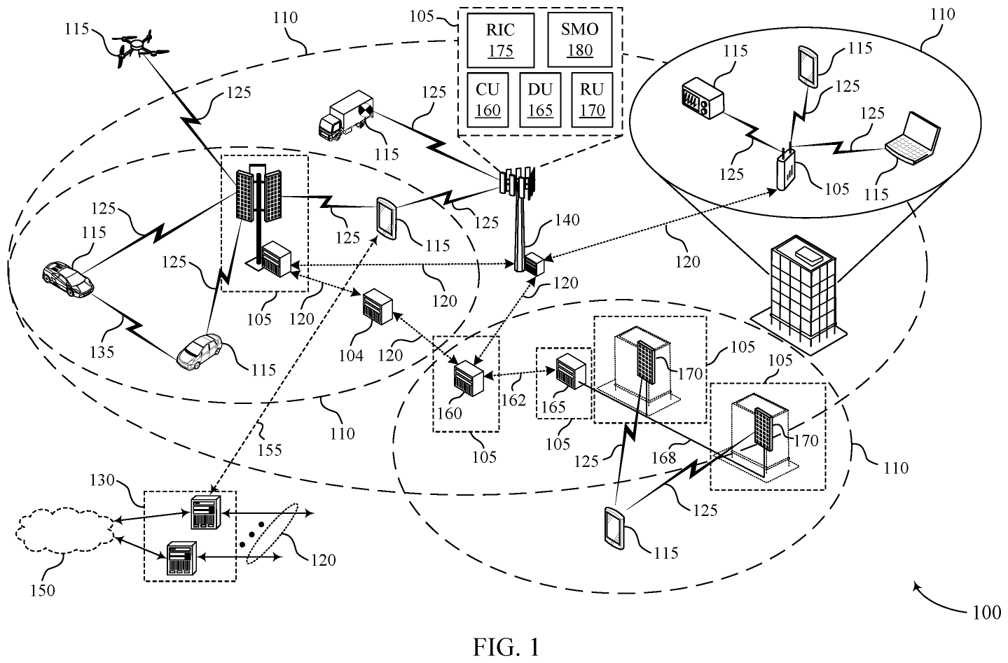

FIG. 1 shows an example of a wireless communications system 100 that supports network energy savings techniques in the presence of camped user equipment in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an Fl interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 may monitor a communication link 125 continuously for an indication that the UE 115 may receive data. In other cases (e.g., to conserve power and extend battery life) a UE 115 may be configured with a DRX cycle. A DRX cycle may include an “On Duration” when the UE 115 may monitor for control information (e.g., via a physical downlink control channel (PDCCH)) and a “DRX period” when the UE 115 may power down one or more radio components. In some cases, a UE 115 may be configured with a short DRX cycle and a long DRX cycle. In some cases, a UE 115 may enter a long DRX cycle if it is inactive for one or more short DRX cycles. The transition between the short DRX cycle, the long DRX cycle and continuous reception may be controlled by an internal timer or by messaging from a network entity 105. A UE 115 may receive scheduling messages via PDCCH during the On Duration. While monitoring PDCCH for a scheduling message, the UE 115 may initiate a “DRX Inactivity Timer.” If a scheduling message is successfully received, the UE 115 may prepare to receive data and the DRX Inactivity Timer may be reset. When the DRX Inactivity Timer expires without receiving a scheduling message, the UE 115 may move into a short DRX cycle and may start a “DRX Short Cycle Timer.” When the DRX Short Cycle Timer expires, the UE 115 may resume a long DRX cycle.

A UE 115 may operate in accordance with various states or modes for communicating with a network. As an example, a UE 115 may operate in an RRC idle state (e.g., RRC_IDLE), an RRC inactive state (e.g., RRC_INACTIVE), and/or an RRC connected state (e.g., RRC_CONNECTED). The UE 115 may transition between the various states or modes, for example, based on communications traffic for the UE 115. In the RRC idle state (which may be referred to as an idle mode), a UE 115 may not be registered to a particular cell, and may accordingly lack an access stratum (AS) context, and the UE 115 may thus not have an active RRC connection established with the network (e.g., via a network entity 105). In the idle mode, the UE 115 may wake up periodically to monitor channels for paging or other signaling, and the mobility of the UE 115 may be managed by the UE 115 when performing measurements of one or more cells. In the RRC connected state (which may be referred to as a connected mode), the UE 115 may have an established RRC connection (e.g., with a 5GC) where the UE 115 may store an AS context. Here, the UE 115 may belong to a known cell and may be identified using a cell radio network temporary identifier (C-RNTI) assigned to the UE 115. While in the connected mode, the UE 115 may monitor for messages transmitted by the network, which may include monitoring various channels (e.g., paging channels, control channels, or the like).

The RRC inactive state may be used to reduce signaling overhead and may provide an intermediate mode (e.g., between idle and connected), which may also be used to reduced latency when transitioning to another mode (e.g., to the connected mode). The UE 115 may periodically wake up while in the inactive mode to monitor for paging messages from the network, where the UE 115 may in some cases, perform a random access procedure to move to the connected mode and communicate with the network.

In some cases, some UEs 115 associated with a cell of a network entity 105 may operate in I-DRX and may remain “camped” on the cell (e.g., a UE 115 may maintain its selection of the cell, a UE 115 may remain associated with the cell). However, the network entity 105 may not have information associated with the inactive UEs 115. Further, the network entity 105 may support one or more energy savings techniques to reduce power consumption but may not be able to reliably employ such techniques without the information associated with the inactive UEs 115. That is, at least some camped UEs 115 may be dropped by the network entity 105 based on the network energy savings techniques, resulting in increased power consumption and decreased communication reliability in the wireless communications system 100.

In accordance with one or more techniques described herein, a UE 115, a network entity 105, and/or other wireless communication devices described herein may support signaling techniques that enable the network entity 105 to obtain information associated with one or more inactive UEs 115 camped on a cell (e.g., within a coverage area 110) and adjust its communication parameters based on the obtained information. For example, the network entity 105 may transmit one or more messages (e.g., a survey indication) to one or more UEs 115 (e.g., idle UEs 115, inactive UEs 115, camped UEs 115) during an active duration of a UE DRX operation (e.g., I-DRX). The one or more messages may request a response message from one or more UEs 115 that includes requested information associated with the UEs 115 (e.g., location information and other information). In some examples, the one or more messages may be transmitted from the network entity 105 in all directions or a subset of directions and may request a response from all inactive UEs 115 or a subset of inactive UEs 115. Accordingly, the network entity 105 may adjust its communication parameters (e.g., associated with network energy savings) based on the response messages from the UEs 115 (e.g., location information, status information, a quantity of camped UEs), which may result in improved energy consumption efficiency, improved communication reliability, and other benefits.

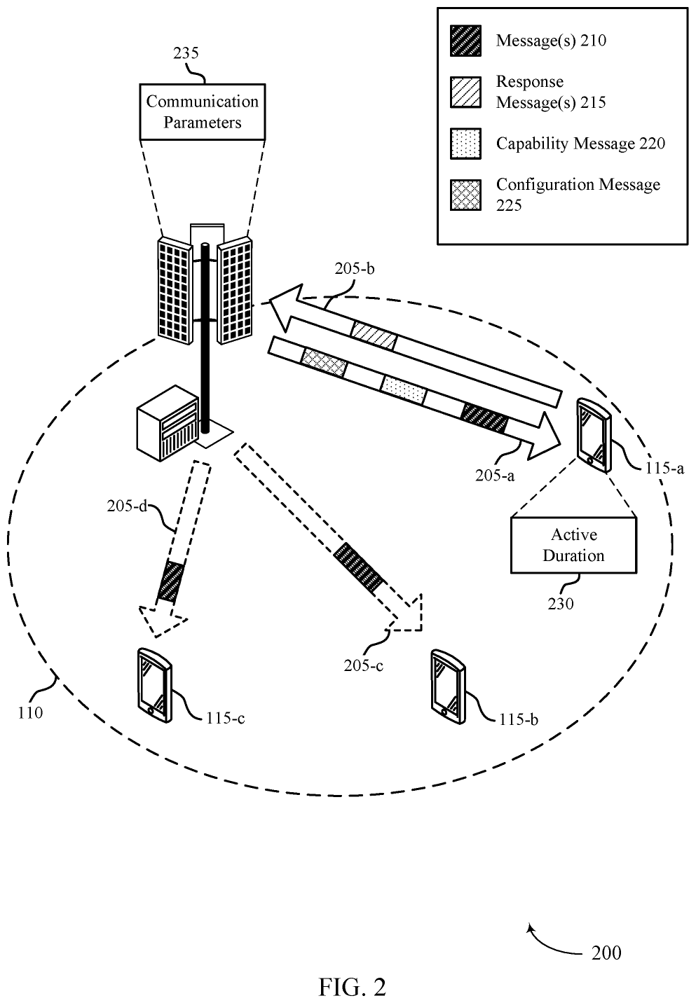

FIG. 2 shows an example of a wireless communications system 200 that supports network energy savings techniques in the presence of camped user equipment in accordance with one or more aspects of the present disclosure. The wireless communications system 200 may implement or be implemented by aspects of the wireless communications system 100 as described with reference to FIG. 1. For example, the wireless communications system 200 may include a network entity 105 and one or more UEs 115 (e.g., a UE 115-a, a UE 115-b, and a UE 115-c), which may be examples of or include devices as described with reference to FIG. 1. The network entity 105 may be associated with a coverage area 110 (e.g., a cell) that includes the one or more UEs 115. The network entity 105 may communicate with the one or more UEs 115 of the coverage area 110 via respective communication links 205 (e.g., communication link 205-a, communication link 205-b, communication link 205-c, communication link 205-d). The communication links 205 may be examples of or include downlink communication interfaces (e.g., the communication link 205-a, the communication link 205-c, the communication link 205-d), uplink communication interfaces (e.g., the communication link 205-b), or other communication interfaces. Although a network entity 105 and UEs 115 are shown as example devices of the wireless communications system 200, the techniques herein may be applied by one or more other devices described herein, including with reference to FIG. 1.

The UEs 115 may be “camping” on a cell (e.g., the coverage area 110) of the network entity 105. That is, the UEs 115 may have selected the (e.g., via cell selection procedures), but may not have active (e.g., pending) communications to perform (e.g., transmit, receive) with the network entity 105. Thus, the UEs 115 may enter a power-saving operation mode (e.g., an idle mode, an inactive mode, a DRX mode, an I-DRX mode, a discontinuous transmission (DTX) mode) to save energy. For example, the UEs may enter an I-DRX mode, which may be associated with non-active durations (e.g., durations in which the UE 115 refrains from performing any communication) and active durations 230. In the active durations 230 of I-DRX, the UEs 115 (e.g., the inactive UEs, the idle UEs) may monitor for signaling (e.g., paging) from the network entity 105, which may indicate whether the UE 115 is to enter an active mode or remain in an inactive mode.

In some cases, the network entity 105 may not have information (e.g., may not have knowledge of) the locations associated with the inactive UEs 115. That is, the UEs 115 may be freely moving within the registered tracking areas (e.g., or within the RAN notification areas (RNAs)) of the network entity 105 without notifying the network entity 105. For instance, the network entity 105 may have information associated with the tracking area code (TAC) and/or the RNA of a UE 115, but the TAC and the RNA may comprise multiple cells (e.g., covering a relatively large distance, across multiple coverage areas 110) and may not provide precise location information associated with the UEs 115. Further, the network entity 105 (e.g., a cell) may provide (e.g., blindly provide) one or more broadcast signals and/or channels to support the UEs 115 (e.g., the idle UE, the inactive UEs, the I-DRX enabled UEs). That is, although the UEs 115 may not be connected to a cell of the network entity 105, the network entity 105 (e.g., the cell) may perform periodic communications to support the inactive UEs 115. For example, the network entity 105 may periodically transmit (e.g., send, output) SSB signals, SIB signals, paging signals (e.g., in all communication directions, in a beam-sweep), or other discovery signaling, and may also periodically monitor for random access channel (RACH) message 1 (Msg1), and other channel access signaling. Such signaling may be associated with relatively high energy (e.g., power) consumption and an increased signaling overhead.

To reduce power consumption, NES techniques may be considered for the network entity 105 such as, for example, making SSB or SIB transmission on-demand, adjusting a configuration (e.g., a transmission power) of the discovery signaling in a cell-specific or beam-specific manner, deactivating such signaling (e.g., SSBs, SIBs, RACH monitoring) in at least some communication directions (e.g., in some beam directions), reducing a frequency (e.g., a periodicity, a quantity of signal instances per unit of time, and making such signals less frequent) of the signaling messages (e.g., SSBs, SIBs, and other such signaling), among other examples. However, if a network entity 105 has a cell that already has one or more UEs 115 (e.g., idle/inactive UEs) camping on the cell, adopting such NES techniques may impact (e.g., adversely impact) the UEs 115, and may result in the UEs 115 being dropped by the cell (e.g., the UEs 115 may get out of service coverage). Thus, the network entity 105 may not be able to efficiently employ NES techniques without potentially affecting the idle UEs 115 and/or inactive UEs 115 that may be camped on the cell (e.g., because the network entity 105 may not have sufficient information to determine whether any such UEs 115 are camping on the cell).

In accordance with one or more aspects of the present disclosure, the network entity 105 may support improved tracking of the inactive UEs 115 that may be camping on the cell (e.g., the network entity 105 may have an increased “visibility” of the camped UEs 115). Such techniques may support reduced network energy consumption, reduced resource overhead, and reduce inter-cell interference (e.g., thus supporting sustainability of next generation wireless communications systems). For example, if a network entity 105 knows (e.g., has information indicative of) that there are no UEs 115 camping in one or more of its beam directions, the network entity 105 may utilize (e.g., adopt, employ) a NES technique for such directions (e.g., for associated SSBs). That is, the network entity 105 may adjust one or more communication parameters 235 transmit (e.g., output, send) SSBs, SIB1, or other signaling less frequently in such directions, or make the signaling on-demand, or temporarily deactivate transmission of SSBs and/or SIB1 in such directions, or employ other NES techniques.

Further, if a network entity 105 knows that there are no UEs 115 in an area relatively close to the cell (e.g., near a cell-center) or in an area relatively far from the cell (e.g., near a cell-edge), the network entity 105 may adjust the one or more communication parameters 235 accordingly (e.g., a transmission configuration of SSB, SIB, paging, RACH). For example, the network entity 105 may adjust the one or more communication parameters 235 to reduce a transmission power if there are no UEs at a cell-edge, or to change a beamforming configuration to steer one or more beams away from a regions that does not include UEs 115. In another example, if a cell knows (e.g., or has an adequate estimation) about a population of the UEs 115 (e.g., a quantity of UEs 115) in some directions and/or regions of a cell, the network entity 105 may adjust the one or more communication parameters 235 accordingly. For instance, the network entity 105 may adjust the one or more communication parameters 235 to determine a quantity of RACH resources to allocate to a given direction based on a level of expected contention, or to balance NES and UE impact (e.g., refrain from using a NES technique if there are a relatively high quantity of UEs 115 (above a threshold) camping on the cell or camping on some beam directions).

In some examples, although the UEs 115 may be in an inactive mode, the UEs 115 may support active durations 230. That is, a UE 115 may wake up (e.g., at least once) for an active duration 230 during its I-DRX cycle to monitor for a paging PDCCH or a short message to determine (e.g., identify, ascertain) if there is a short message for the UE 115 (e.g., if there is system information (SI) update) and if there is a paging message for the UE 115. The UE 115 may wake up early (e.g., before its paging occasion) or stay on (e.g., stay active) longer (e.g., after its paging occasion) to perform one or more measurements (e.g., and adjust its beams, time resources, frequency resources) of the camped cell and may perform (e.g., run) intra- and inter-frequency cell search to identify (e.g., find) other potential cells (e.g., a cell associated with higher communication strength or quality) for camping. That is, a UE 115 may support some activity within its active duration 230 (e.g., ON duration) and may be utilized to support one or more techniques herein.

Thus, a network entity 105 may be configured to communicate with the one or more UEs 115 during the active durations 230. For example, a network entity 105 (e.g., a cell) may output (e.g., transmit, send, convey) one or more messages 210 (e.g., a short “survey” indication) during the active duration 230 (e.g., the ON duration) of the DRX operation (e.g., of the I-DRX cycles). The one or more messages 210 may request the camped UEs 115 to respond (e.g., to the network entity 105) with one or more response messages 215 (e.g., a keep-alive or wake-up signal). Based on monitoring for the one or more response messages 215 from the camped UEs 115, the network entity 105 may obtain (e.g., acquire, receive, determine) some information about the camped UEs 115 (e.g., if any), and may adjust one or more of its configurations (e.g., communication parameters 235) associated with NES techniques or other communication configurations.

The one or more messages 210 (e.g., the survey indications) may be communicated (e.g., be included in, be carried by) via various signaling such as a paging PDCCH message (e.g., carried by short message within the paging PDCCH), a paging early indication (PEI) message, a WUS message (e.g., a low power-WUS (LP-WUS)), a paging physical downlink shared channel (PDSCH) message, a PDCCH message, a PDSCH message, or a combination thereof. The one or more messages 210 may be communicated in all communication directions or a subset of directions (e.g., in accordance with a directional communication parameter configured by the network entity 105). For example, the network entity 105 may transmit a message 210 in a first direction (e.g., via the communication link 205-a to the UE 115-a) and a second direction (e.g., via the communication link 205-c to the UE 115-b) and may refrain from transmitting the message 210 in a third direction (e.g., via the communication link 205-d to the UE 115-c).

In some examples, the one or more messages 210 may request a response message 215 from all of the UEs 115 within the cell (e.g., the coverage area 110, the UE 115-a, the UE 115-b, and the UE 115-c) or may request a response message 215 from subset of UEs 115 within the cell (e.g., the one or more messages 210 may be applicable to all UEs 115 or a subset of UEs 115). For example, the one or more messages 210 may request a response message 215 from idle UEs 115, inactive UEs 115, UEs 115 that belong to a given group or a given sub-group (e.g., associated with a same group identifier), UEs 115 that are associated with a same paging occasion, UEs 115 that are associated with a same paging frame, UEs 115 of a specific type (e.g., reduced capability (RedCap) UEs, normal UEs, IAB-MT UEs, network-controlled repeater-mobile termination (NCR-MT), and other UE types), UEs 115 of a specific mobility state (e.g., stationary UEs, mobile UEs, mobile UEs according to a level of mobility), UEs 115 that are on-board a mobile cell (e.g., a mobile IAB and/or vehicle mounted relay (VMR)), UEs 115 that surround a mobile cell (e.g., not on-board), UEs 115 that are associated with a same region and/or zone of a cell, or a combination thereof. In some examples, a region or zone may be defined based on any combination of a reference signal receive power (RSRP) threshold of the cell (e.g., and/or thresholds of neighbor cells), a geo-location, a result of sensing, being in coverage of an assisting node such as a repeater or a reconfigurable intelligent surface (RIS), or being able to detect multiple beams. Additionally, in some examples, the network entity 105 may repeat a transmission of the one or more messages 210 if the network entity 105 fails to receive a response message 215.

In some examples, one or more UEs 115 may transmit one or more response messages 215 to the network entity 105 based on (e.g., in response to, after) receiving the one or more messages 210. The one or more response messages 215 may be included in an uplink KAS, an uplink WUS, or some other signal. In some examples, the one or more response messages 215 may be carried by (e.g., included in, communicated via) a reference signal, a physical random access channel (PRACH) message, a physical uplink control channel (PUCCH) message, a physical uplink shared channel (PUSCH) message, a preamble and/or a payload of a two-step RACH process, or a combination thereof. Information associated with a UE 115 (e.g., the information requested by a message 210) may be carried by a choice (e.g., by the UE 115) of the signal for the response message 215 (e.g., a preamble associated with the response message 215, a scrambling identifier associated with the response message 215) and/or a choice of the resources (e.g., time resources and/or frequency resources) for transmitting the response message 215. For example, the UE 115-a may transmit a response message 215 on an occasion associated with a beam direction (e.g., similar to SSB), which may implicitly provide spatial direction information associated with the UE 115-a (e.g., and differentiate the UE 115-a from the UE 115-b and the UE 115-c).

In some examples, the UE 115 may choose a signal for the response message 215 (e.g., choose a preamble identifier) based on an estimated RSRP or pathloss (PL) from the camped cell, a mobility state of the UE 115, an idle-mode being activated, a given group identifier or sub-group identifier, a given paging occasion, a given paging frame, a type of the UE 115, being on-board a mobile cell, a coverage region and/or zone of a cell, or a combination thereof. For example, a UE 115-a may select a first preamble identifier for its response message 215 based on being an inactive UE (e.g., a camped UE) and a UE 115-b may select a second preamble identifier (e.g., different from the first preamble identifier) for its response message based on being an active UE. To determine (e.g., identify, obtain, detect) information associated with a population (e.g., a quantity) of the UEs 115 (e.g., UEs 115 that are camped in a first beam direction), multiple preamble identifiers (e.g., such as in RACH) may be configured (e.g., by the network entity 105), and each UE 115 may select (e.g., randomly select) a preamble identifier to use for its own response message 215. Thus, the network entity 105 may determine how many different identifiers are detected, which may be an indication of the population of the UEs 115 associated with the cell.

In some examples, the network entity 105 and the one or more UEs 115 may communicate further signaling to support NES techniques with camped UEs. For example, a UE 115 (e.g., the UE 115-a) may receive a capability message 220 from the network entity 105, which may indicate whether a cell supports (e.g., adopts, employs) a capability to communicate the one or more messages 210 and the one or more response message 215 within the active durations 230. If so, the UE 115 may further receive a configuration message 225, which may indicate a configuration for such communications (e.g., configurations and resources used for monitoring and receiving the one or more messages 210 and configurations and resources used for sending the response message 215). In some examples, the capability message 220, the configuration message 225, or both, may be provided semi-statically (e.g., in a SIB) by the cell and/or other cells (e.g., neighbor cells), provided in a dedicated RRC message (e.g., before sending a UE 115 to an idle/inactive state). In some examples, the signaling of the one or more messages 210 and the response message 215 may be dynamically activated and deactivated (e.g., or adjusted) via a broadcast message (e.g., a PEI message, a LP-WUS message, a paging PDCCH, or other broadcast message).

Additionally, a UE 115 (e.g., a camped UE) may have some information about its vicinity (e.g., either by performing a sensing procedure, or via a local communication and/or discovery of other UEs), which may also be communicated to the network entity 105 (e.g., shared with the network, communicated via the one or more response messages 215). For example, the UE 115-a may have information associated with an area within a threshold distance of the UE 115-a (e.g., interference information, channel quality, a quantity of UEs 115). In some examples, a UE 115 may establish a connection with the network entity 105 to provide the information (e.g., the one or more response messages 215). Additionally, or alternatively, a connected UE 115 may have information (e.g., associated with inactive UEs) that can be communicated (e.g., shared) with the network entity 105. Additionally, or alternatively, if there are multiple collaborating UEs 115, the UEs 115 may coordinate with each other such that a single UE 115 or a subset of UEs 115 would respond to the network entity 105 (e.g., with a response message 215) or connect with the network entity 105 to provide such information.

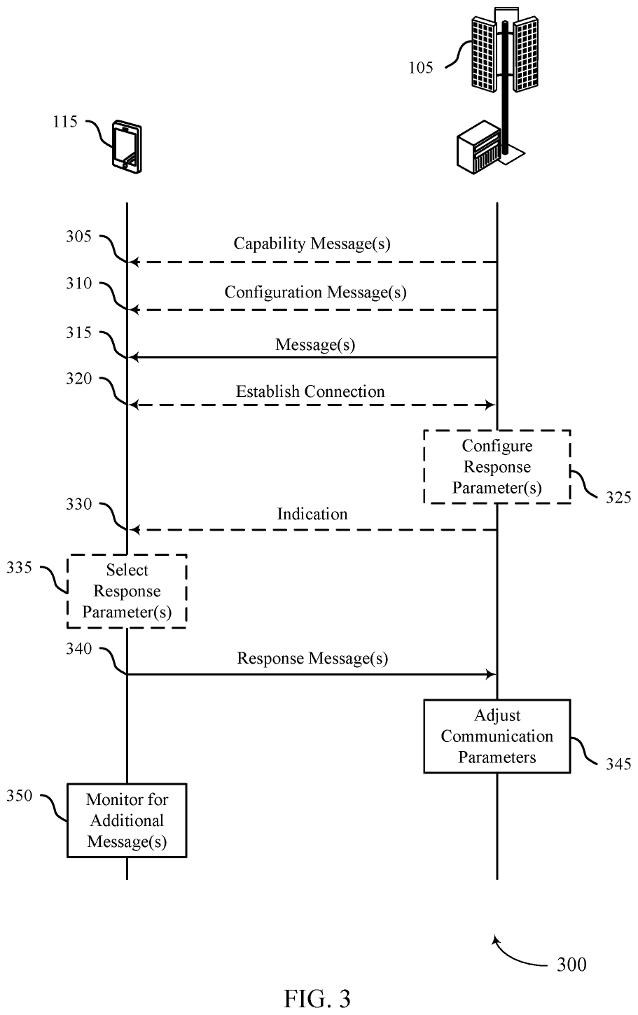

FIG. 3 shows an example of a process flow 300 that supports network energy savings techniques in the presence of camped user equipment in accordance with one or more aspects of the present disclosure. In some examples, the process flow 300 may implement aspects of the wireless communications system 100 and the wireless communications system 200. For example, the process flow 300 may support signaling between a UE 115 and a network entity 105 to enable tracking of inactive UEs 115 with a cell of the network entity 105. In the following description of the process flow 300, the operations between the UE 115 and the network entity 105 may be performed in a different order than the order shown, or other operations may be added or removed from the process flow 300. For example, some operations may also be left out of the process flow 300, or may be performed in different orders or at different times. Further, although some operations or signaling may be shown to occur at different times for discussion purposes, these operations may actually occur at the same time. Although the UE 115 and the network entity 105 are shown performing the operations of the process flow 300, some aspects of some operations may also be performed by one or more other wireless or network devices.

At 305, in some examples, the UE 115 may receive a capability message (e.g., a capability message 220), which may be output (e.g., transmitted, sent) from the network entity 105. The capability message may indicate whether a cell of the network entity 105 supports communication of a message (e.g., one or more messages 210, a survey indication) and a response message (e.g., one or more response messages 215, uplink KAS, uplink WUS) in accordance with an active duration of a DRX operation (e.g., an ON duration of I-DRX) at the UE 115. In some examples, the UE 115 may receive the message in accordance with the DRX operation based on receiving the capability message. The capability message may be received via a SIB message, an RRC message, a broadcast message (e.g., PEI, LP-WUS, paging PDCCH, paging PDSCH), or any combination thereof.

At 310, in some examples, the UE 115 may receive a configuration message (e.g., a configuration message 225), which may be output (e.g., transmitted, sent) from the network entity 105. The configuration message may indicates one or more message parameters associated with receiving the message (e.g., the message 210) and one or more response parameters associated with transmitting the response message (e.g., the response message 215). In some examples, receiving the message, transmitting the response message, or both, may be based on the configuration message. The configuration message may be received via a SIB message, an RRC message, a broadcast message (e.g., PEI, LP-WUS, paging PDCCH, paging PDSCH), or any combination thereof.

At 315, the UE 115 may receive a message in accordance with an active duration of the DRX operation at the UE, which may be output (e.g., transmitted, sent) by the network entity 105. The message may include a request for information indicative of a location of the UE within a cell associated with the network entity 105. In some examples, the UE 115 may receive the message via a paging PDCCH message, a PEI message, a WUS message, or any combination thereof. In some examples, the UE 115 may receive the message in accordance with a directional parameter (e.g., in accordance with a specific beam direction) associated with the message, and the directional parameter may be configured by the network entity 105.

At 320, in some examples, the UE 115 may establish a connection with the network entity 105 based on receiving the message. For example, in order to communicate the information requested by the message received from the network entity 105 (e.g., or other information obtained by the UE 115), the UE 115 may establish a connection to transmit the information. Alternatively, the UE 115 may transmit the information to the network entity 105 without establishing a connection.

At 325, in some examples, the network entity 105 may configure a set of preamble identifiers to use for obtaining one or more response messages. For example, the network entity 105 may obtain (e.g., receive) one or more response messages (e.g., response messages 215) based on configuring the set of preamble identifiers, and each preamble identifier of the set of preamble identifier may be used to differentiate respective response messages received from one or more UEs 115.

At 330, in some examples, the network entity 105 may output an indication of the preamble identifier, the scrambling identifier, the resource configuration, or any combination thereof, which may be received by the UE 115. The indication may be based on an RSRP associated with the cell, a pathloss associated with the cell, a mobility state of the UE 115, a coverage region of the cell associated with the UE 115, a type associated with the UE 115, or any combination thereof. In some examples, the network entity 105 may obtain the response message from the UE 115 based on outputting the indication.

At 335, in some examples, the UE 115 may select one or more parameters associated with transmitting a response message. For example, the UE 115 may select a preamble identifier, a scrambling identifier, a resource configuration, or any combination thereof. The selection may be based on an RSRP associated with the cell, a pathloss associated with the cell, a mobility state of the UE, a coverage region of the cell associated with the UE, a type associated with the UE, or any combination thereof. In some examples, the UE 115 may transmit the response message based on the selection of the one or more parameters. In some examples, the UE 115 may select (e.g., at random) a preamble identifier to use for the response message from a set of preamble identifiers configured by the network entity 105 (e.g., at 325), and the UE 115 may transmit the response message based on selecting the preamble identifier.

At 340, the UE 115 may transmit, within the active duration, a response message, which may be obtained (e.g., received) by the network entity 105. The UE 115 may transmit the response message based on (e.g., in response to, after) receiving the message from the network entity 105 (e.g., at 315). The response message may indicate the information associated with the location of the UE within the cell associated with the network entity 105. In some examples, the request for the information (e.g., the request included in the message from the network entity 105) may be applicable to a set of UEs (e.g., a subset of UEs within a cell) associated with the network entity 105. The UE 115 may transmit the response message based being included (e.g., determining that the UE is included) in the set of UEs. For example, the set of UEs may correspond to a set of inactive UEs, a set of UEs associated with a same group identifier, a set of UEs associated with a same paging occasion, a set of UEs associated with a same paging frame, a set of UEs associated with a same UE type, a set of UEs associated with a same mobility state, a set of UEs associated with a same coverage region of the cell, or any combination thereof.

In some examples, the UE 115 may transmit the response message via an uplink KAS message, an uplink WUS message, or both. The UE 115 may transmit the response message in accordance with a preamble identifier, a scrambling identifier, a resource configuration, or any combination thereof. In some examples, the information may be indicative of the location of the UE based on the preamble identifier, the scrambling identifier, the resource configuration, or any combination thereof (e.g., based on a selection of the parameters and resources used for the response message). In some examples, the UE 115 may transmit a second message (e.g., a second response message) to the network entity 105. The second message may include second information associated with an area of the cell that is within a distance threshold of the UE 115. In some examples, the UE 115 may transmit the response message, the second message, or both to the network entity 105 based on establishing the connection at 320). At 345, the network entity 105 may adjust one or more communication

parameters (e.g., one or more communication parameters 235) associated with the cell based on receiving the one or more response messages from the UE 115. For example, the network entity 105 may adjust one or more of a quantity of discovery signals (e.g., SSB message, SIB messages, RACH messages) transmitted within a duration (e.g., may adjust a periodicity of the discovery signal transmissions, a quantity of transmissions per unit of time) and associated with one or more communication directions (e.g., beam directions), a transmit power parameter of the network entity 105, a directional communication parameter, a quantity of RACH resources associated with one or more communication directions, or any combination thereof. Such adjustments may enable the network entity 105 to utilize an NES technique with reduced impact to the UE 115 (e.g., to camped UEs).

At 350, the UE 115 may monitor for one or more additional messages from the network entity 105 in accordance with the DRX operation and based on transmitting the response message. That is, the UE 115 may maintain its selection of the network entity 105 based on communicating the message and the response message with the active duration of the DRX operation at the UE. Thus, the UE 115 may operate in a DRX mode and reliably remain camped on the cell without repeatedly performing cell selection procedures.

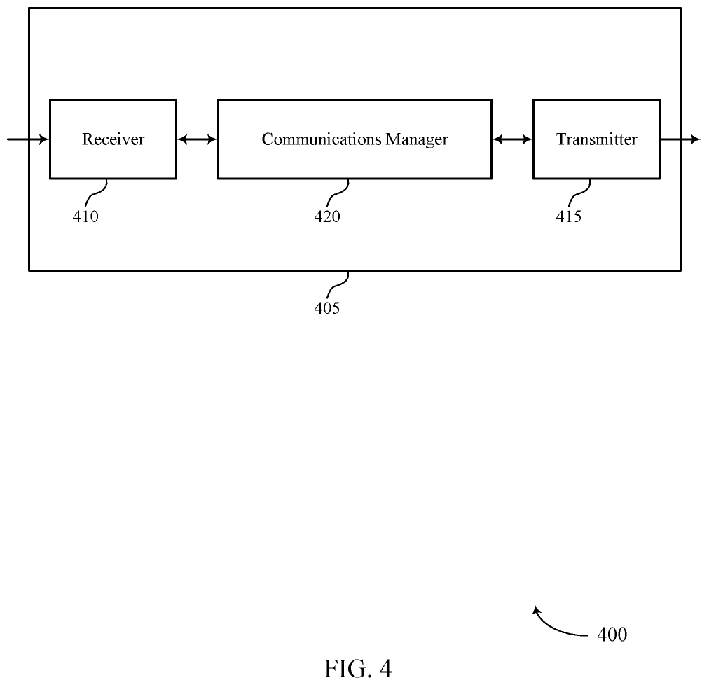

FIG. 4 shows a block diagram 400 of a device 405 that supports network energy savings techniques in the presence of camped user equipment in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to network energy savings techniques in the presence of camped user equipment). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to network energy savings techniques in the presence of camped user equipment). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of network energy savings techniques in the presence of camped user equipment as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a network entity, a message in accordance with an active duration of a discontinuous reception operation at the UE, where the message includes a request for information indicative of a location of the UE within a cell associated with the network entity. The communications manager 420 is capable of, configured to, or operable to support a means for transmitting, within the active duration, a response message to the network entity based on receiving the message, where the response message indicates the information associated with the location of the UE within the cell. The communications manager 420 is capable of, configured to, or operable to support a means for monitoring for one or more additional messages from the network entity in accordance with the discontinuous reception operation and based on transmitting the response message.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources, among other benefits. For example, by including or configuring the communications manager 420 in accordance with examples as described herein, the device 405 may respond to survey messages from a network to enable the network to determine a location of the device 405 (e.g., a geographic location, an area, a region, a cell, or the like), which may ensure that the device 405 continues to receive signaling from a network entity (e.g., while the device 405 and/or the network entity is in a power-saving mode), thereby maintaining communications continuity and efficiency while simultaneously reducing or minimizing power consumption (e.g., for both the device 405 and the network entity).

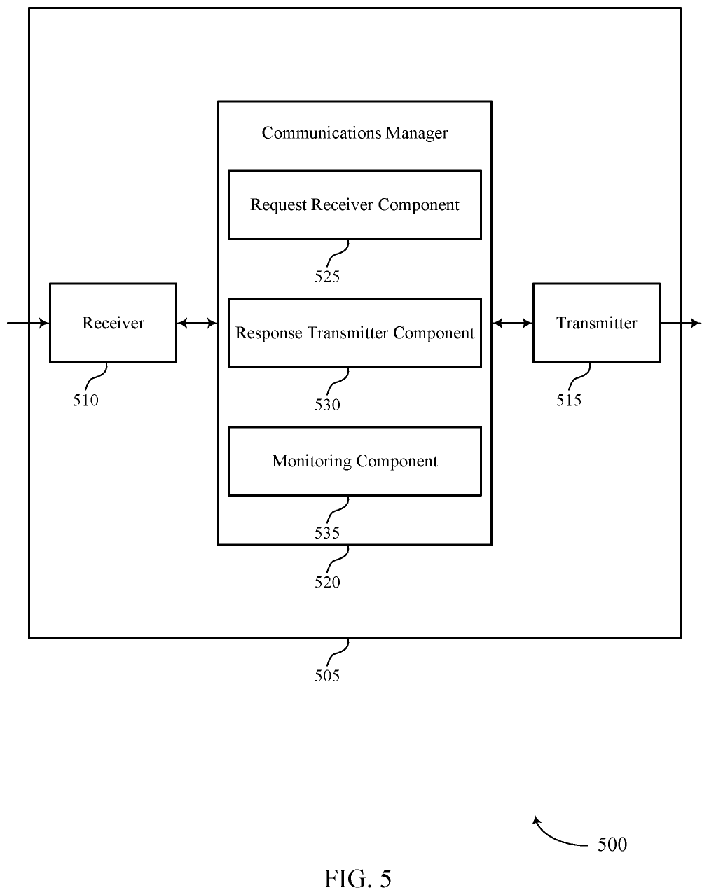

FIG. 5 shows a block diagram 500 of a device 505 that supports network energy savings techniques in the presence of camped user equipment in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to network energy savings techniques in the presence of camped user equipment). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to network energy savings techniques in the presence of camped user equipment). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of network energy savings techniques in the presence of camped user equipment as described herein. For example, the communications manager 520 may include a request receiver component 525, a response transmitter component 530, a monitoring component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The request receiver component 525 is capable of, configured to, or operable to support a means for receiving, from a network entity, a message in accordance with an active duration of a discontinuous reception operation at the UE, where the message includes a request for information indicative of a location of the UE within a cell associated with the network entity. The response transmitter component 530 is capable of, configured to, or operable to support a means for transmitting, within the active duration, a response message to the network entity based on receiving the message, where the response message indicates the information associated with the location of the UE within the cell. The monitoring component 535 is capable of, configured to, or operable to support a means for monitoring for one or more additional messages from the network entity in accordance with the discontinuous reception operation and based on transmitting the response message.

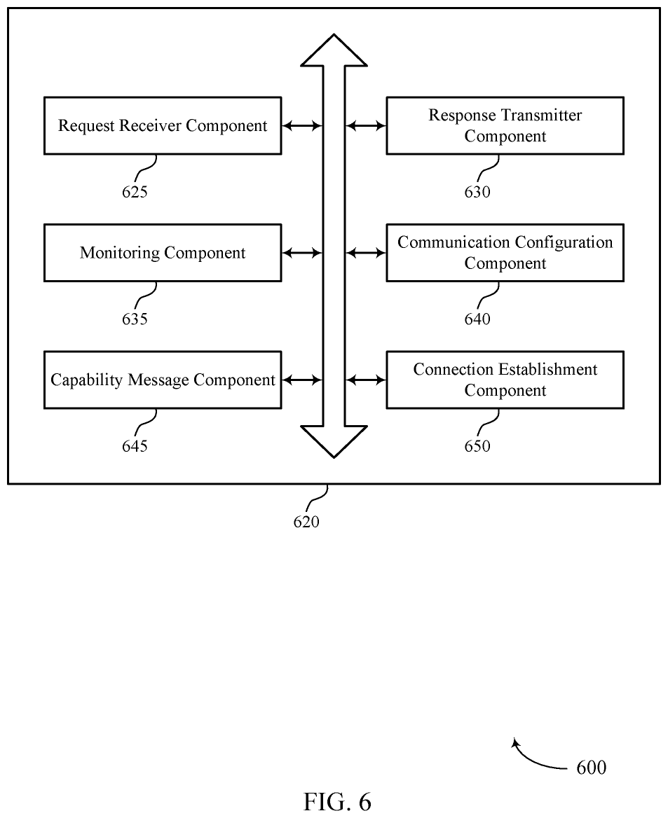

FIG. 6 shows a block diagram 600 of a communications manager 620 that supports network energy savings techniques in the presence of camped user equipment in accordance with one or more aspects of the present disclosure. The communications manager 620 may be an example of aspects of a communications manager 420, a communications manager 520, or both, as described herein. The communications manager 620, or various components thereof, may be an example of means for performing various aspects of network energy savings techniques in the presence of camped user equipment as described herein. For example, the communications manager 620 may include a request receiver component 625, a response transmitter component 630, a monitoring component 635, a communication configuration component 640, a capability message component 645, a connection establishment component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The request receiver component 625 is capable of, configured to, or operable to support a means for receiving, from a network entity, a message in accordance with an active duration of a discontinuous reception operation at the UE, where the message includes a request for information indicative of a location of the UE within a cell associated with the network entity. The response transmitter component 630 is capable of, configured to, or operable to support a means for transmitting, within the active duration, a response message to the network entity based on receiving the message, where the response message indicates the information associated with the location of the UE within the cell. The monitoring component 635 is capable of, configured to, or operable to support a means for monitoring for one or more additional messages from the network entity in accordance with the discontinuous reception operation and based on transmitting the response message.

In some examples, to support receiving the message, the request receiver component 625 is capable of, configured to, or operable to support a means for receiving the message via a paging PDCCH message, a paging early indication message, a wake-up signal message, or any combination thereof.

In some examples, to support receiving the message, the request receiver component 625 is capable of, configured to, or operable to support a means for receiving the message in accordance with a directional parameter associated with the message, where the directional parameter is configured by the network entity.

In some examples, the request for the information is applicable to a set of UEs associated with the network entity. In some examples, transmitting the response message is based on the UE being included in the set of UEs.

In some examples, the set of UEs corresponds to a set of inactive UEs, a set of UEs associated with a same group identifier, a set of UEs associated with a same paging occasion, a set of UEs associated with a same paging frame, a set of UEs associated with a same UE type, a set of UEs associated with a same mobility state, a set of UEs associated with a same coverage region of the cell, or any combination thereof.

In some examples, to support transmitting the response message, the response transmitter component 630 is capable of, configured to, or operable to support a means for transmitting the response message via an uplink keep-alive signal message, an uplink wake-up signal message, or both.

In some examples, to support transmitting the response message, the response transmitter component 630 is capable of, configured to, or operable to support a means for transmitting the response message in accordance with a preamble identifier, a scrambling identifier, a resource configuration, or any combination thereof, where the information is indicative of the location of the UE based on the preamble identifier, the scrambling identifier, the resource configuration, or any combination thereof.

In some examples, the communication configuration component 640 is capable of, configured to, or operable to support a means for selecting the preamble identifier, the scrambling identifier, the resource configuration, or any combination thereof based on a RSRP associated with the cell, a pathloss associated with the cell, a mobility state of the UE, a coverage region of the cell associated with the UE, a type associated with the UE, or any combination thereof, where transmitting the response message is based on the selecting.

In some examples, the communication configuration component 640 is capable of, configured to, or operable to support a means for selecting a preamble identifier to use for transmitting the response message from a set of preamble identifiers configured by the network entity, where transmitting the response message is based on selecting the preamble identifier.

In some examples, the capability message component 645 is capable of, configured to, or operable to support a means for receiving a capability message from the network entity that indicates whether the cell of the network entity supports communication of the message and the response message in accordance with the active duration of the discontinuous reception operation at the UE, where receiving the message is based on receiving the capability message.

In some examples, the communication configuration component 640 is capable of, configured to, or operable to support a means for receiving a configuration message from the network entity that indicates one or more message parameters associated with receiving the message and one or more response parameters associated with transmitting the response message, where receiving the message or transmitting the response message, or both, are based on the configuration message.

In some examples, the communication configuration component 640 is capable of, configured to, or operable to support a means for receiving a capability message associated with the message and the response message, a configuration message associated with the message and the response message, or both via a SIB message, an RRC message, a broadcast message, or any combination thereof.

In some examples, the response transmitter component 630 is capable of, configured to, or operable to support a means for transmitting a second message to the network entity, the second message including second information associated with an area of the cell that is within a distance threshold of the UE.

In some examples, the connection establishment component 650 is capable of, configured to, or operable to support a means for establishing a connection with the network entity based on receiving the message. In some examples, the response transmitter component 630 is capable of, configured to, or operable to support a means for transmitting the response message, the second message, or both to the network entity based on establishing the connection.

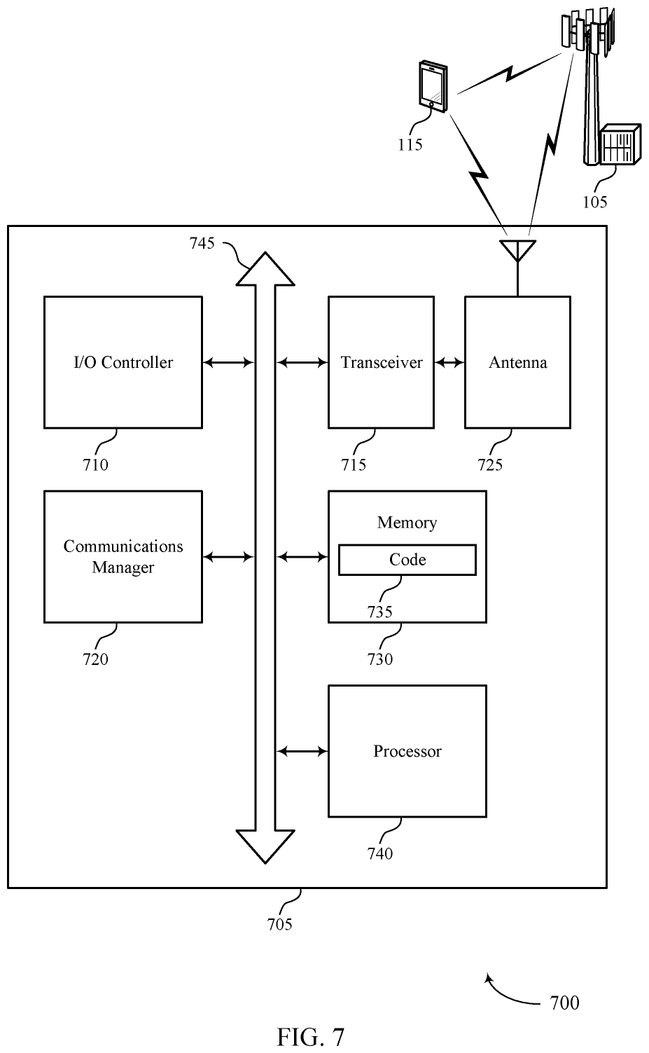

FIG. 7 shows a diagram of a system 700 including a device 705 that supports network energy savings techniques in the presence of camped user equipment in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICS, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting network energy savings techniques in the presence of camped user equipment). For example, the device 705 or a component of the device 705 may include at least one processor 740 and at least one memory 730 coupled with or to the at least one processor 740, the at least one processor 740 and the at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, from a network entity, a message in accordance with an active duration of a discontinuous reception operation at the UE, where the message includes a request for information indicative of a location of the UE within a cell associated with the network entity. The communications manager 720 is capable of, configured to, or operable to support a means for transmitting, within the active duration, a response message to the network entity based on receiving the message, where the response message indicates the information associated with the location of the UE within the cell. The communications manager 720 is capable of, configured to, or operable to support a means for monitoring for one or more additional messages from the network entity in accordance with the discontinuous reception operation and based on transmitting the response message.

By including or configuring the communications manager 720 in accordance with examples as described herein, the device 705 may support techniques for improved communication reliability, improved user experience related to reduced processing, reduced power consumption, more efficient utilization of communication resources, improved coordination between devices, and longer battery life, among other benefits. For example, by including or configuring the communications manager 720 in accordance with examples as described herein, the device 705 may respond to survey messages from a network to enable the network to determine a location of the device 705 (e.g., a geographic location, an area, a region, a cell, or the like), which may ensure that the device 705 continues to receive signaling from a network entity (e.g., while the device 705 and/or the network entity is in a power-saving mode), thereby maintaining communications continuity and efficiency while simultaneously reducing or minimizing power consumption (e.g., for both the device 705 and the network entity).

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of network energy savings techniques in the presence of camped user equipment as described herein, or the at least one processor 740 and the at least one memory 730 may be otherwise configured to, individually or collectively, perform or support such operations.

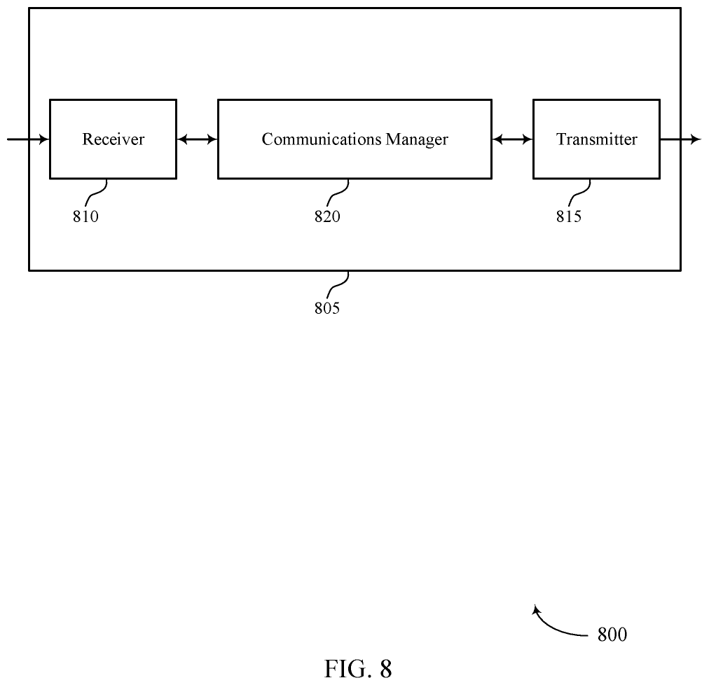

FIG. 8 shows a block diagram 800 of a device 805 that supports network energy savings techniques in the presence of camped user equipment in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of network energy savings techniques in the presence of camped user equipment as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting a message to a UE in accordance with an active duration of a discontinuous reception operation the UE, where the message includes a request for information indicative of a location of the UE within a cell associated with the network entity. The communications manager 820 is capable of, configured to, or operable to support a means for obtaining, within the active duration, a response message from the UE based on transmitting the message, where the response message indicates the information associated with the location of the UE within the cell. The communications manager 820 is capable of, configured to, or operable to support a means for adjusting one or more communication parameters associated with the cell based on receiving the response message from the UE.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources, among other benefits. For example, by including or configuring the communications manager 820 in accordance with examples as described herein, the device 805 may receive responses from one or more UEs that may be used by the device 805 to determine a location of the respective UEs (e.g., a geographic location, an area, a region, a cell, or the like), which may ensure that the device 805 is able to maintain service to the respective UEs (e.g., while the device 805 and/or the UEs are in a power-saving mode), thereby maintaining communications continuity and efficiency while simultaneously reducing or minimizing power consumption (e.g., for both the device 805 and the UEs).

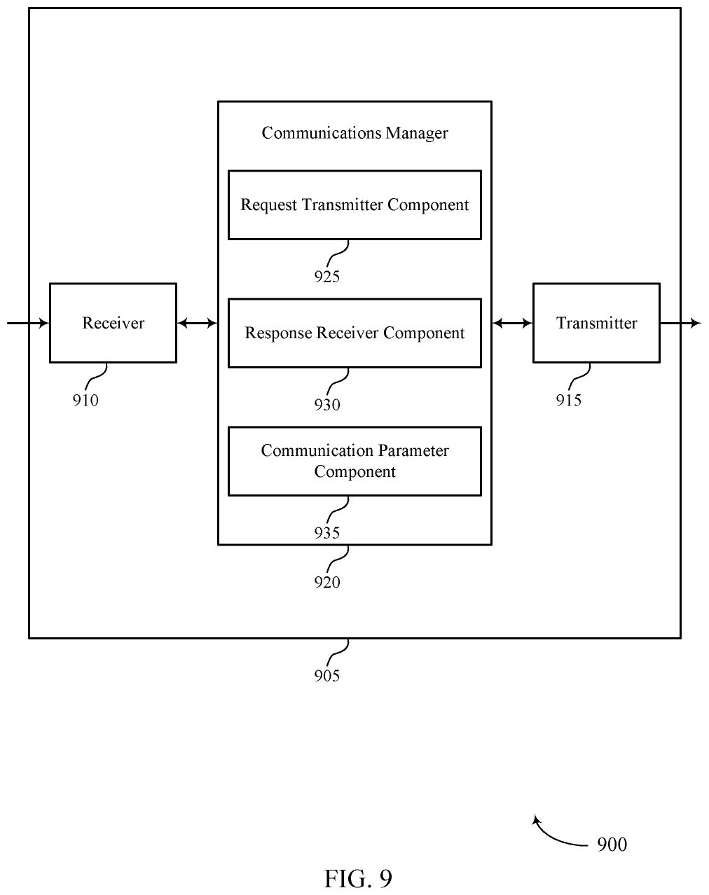

FIG. 9 shows a block diagram 900 of a device 905 that supports network energy savings techniques in the presence of camped user equipment in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of network energy savings techniques in the presence of camped user equipment as described herein. For example, the communications manager 920 may include a request transmitter component 925, a response receiver component 930, a communication parameter component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The request transmitter component 925 is capable of, configured to, or operable to support a means for outputting a message to a UE in accordance with an active duration of a discontinuous reception operation the UE, where the message includes a request for information indicative of a location of the UE within a cell associated with the network entity. The response receiver component 930 is capable of, configured to, or operable to support a means for obtaining, within the active duration, a response message from the UE based on transmitting the message, where the response message indicates the information associated with the location of the UE within the cell. The communication parameter component 935 is capable of, configured to, or operable to support a means for adjusting one or more communication parameters associated with the cell based on receiving the response message from the UE.

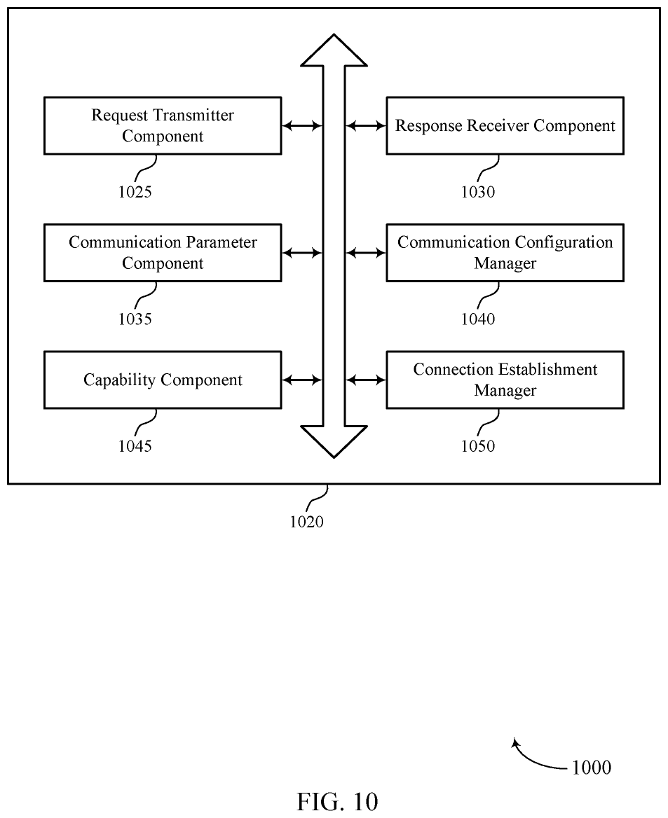

FIG. 10 shows a block diagram 1000 of a communications manager 1020 that supports network energy savings techniques in the presence of camped user equipment in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of network energy savings techniques in the presence of camped user equipment as described herein. For example, the communications manager 1020 may include a request transmitter component 1025, a response receiver component 1030, a communication parameter component 1035, a communication configuration manager 1040, a capability component 1045, a connection establishment manager 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The request transmitter component 1025 is capable of, configured to, or operable to support a means for outputting a message to a UE in accordance with an active duration of a discontinuous reception operation the UE, where the message includes a request for information indicative of a location of the UE within a cell associated with the network entity. The response receiver component 1030 is capable of, configured to, or operable to support a means for obtaining, within the active duration, a response message from the UE based on transmitting the message, where the response message indicates the information associated with the location of the UE within the cell. The communication parameter component 1035 is capable of, configured to, or operable to support a means for adjusting one or more communication parameters associated with the cell based on receiving the response message from the UE.

In some examples, to support adjusting the one or more communication parameters, the communication parameter component 1035 is capable of, configured to, or operable to support a means for adjusting one or more of a quantity of discovery signals transmitted within a time duration and associated with one or more communication directions, a transmit power parameter of the network entity, a directional communication parameter, a quantity of random access channel resources associated with one or more communication directions, or any combination thereof.

In some examples, to support outputting the message, the request transmitter component 1025 is capable of, configured to, or operable to support a means for outputting the message via a paging PDCCH message, a paging early indication message, a wake-up signal message, or any combination thereof.

In some examples, to support outputting the message, the request transmitter component 1025 is capable of, configured to, or operable to support a means for outputting the message in accordance with a directional parameter associated with the message, where the message is output in one or more directions from the network entity based on the directional parameter.

In some examples, the request for the information is applicable to a set of UEs associated with the network entity. In some examples, obtaining the response message is based on the UE being included in the set of UEs.

In some examples, the set of UEs corresponds to a set of inactive UEs, a set of UEs associated with a same group identifier, a set of UEs associated with a same paging occasion, a set of UEs associated with a same paging frame, a set of UEs associated with a same UE type, a set of UEs associated with a same mobility state, a set of UEs associated with a same coverage region of the cell, or any combination thereof.

In some examples, to support obtaining the response message, the response receiver component 1030 is capable of, configured to, or operable to support a means for obtaining the response message via an uplink keep-alive signal message, an uplink wake-up signal message, or both.

In some examples, to support obtaining the response message, the response receiver component 1030 is capable of, configured to, or operable to support a means for obtaining the response message in accordance with a preamble identifier, a scrambling identifier, a resource configuration, or any combination thereof, where the information is indicative of the location of the UE based on the preamble identifier, the scrambling identifier, the resource configuration, or any combination thereof.

In some examples, the communication configuration manager 1040 is capable of, configured to, or operable to support a means for outputting an indication of the preamble identifier, the scrambling identifier, the resource configuration, or any combination thereof based on a RSRP associated with the cell, a pathloss associated with the cell, a mobility state of the UE, a coverage region of the cell associated with the UE, a type associated with the UE, or any combination thereof, where obtaining the response message is based on outputting the indication.

In some examples, the communication configuration manager 1040 is capable of, configured to, or operable to support a means for configuring a set of preamble identifiers to use for obtaining one or more response messages, where obtaining the response message is based on configuring the set of preamble identifiers.

In some examples, the capability component 1045 is capable of, configured to, or operable to support a means for outputting a capability message to the UE that indicates whether the cell of the network entity supports communication of the message and the response message in accordance with the active duration of the discontinuous reception operation at the UE, where outputting the message is based on outputting the capability message.

In some examples, the communication configuration manager 1040 is capable of, configured to, or operable to support a means for outputting a configuration message to the UE that indicates one or more message parameters associated with outputting the message and one or more response parameters associated with obtaining the response message.

In some examples, the communication configuration manager 1040 is capable of, configured to, or operable to support a means for outputting a capability message associated with the message and the response message, a configuration message associated with the message and the response message, or both via a SIB message, an RRC message, a broadcast message, or any combination thereof.

In some examples, the response receiver component 1030 is capable of, configured to, or operable to support a means for obtaining, based on outputting the message, a second message, the second message including second information associated with an area of the cell that is within a distance threshold of the UE.

In some examples, the connection establishment manager 1050 is capable of, configured to, or operable to support a means for establishing a connection with the UE based on outputting the message. In some examples, the response receiver component 1030 is capable of, configured to, or operable to support a means for obtaining the response message, the second message, or both from the UE based on establishing the connection.

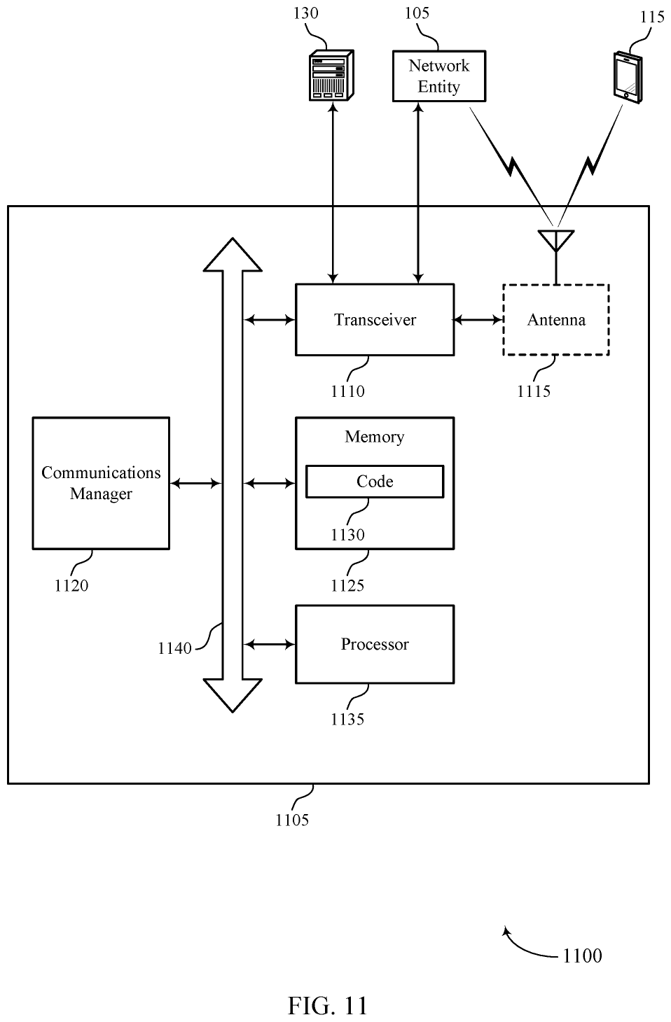

FIG. 11 shows a diagram of a system 1100 including a device 1105 that supports network energy savings techniques in the presence of camped user equipment in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting network energy savings techniques in the presence of camped user equipment). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network devices, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting a message to a UE in accordance with an active duration of a discontinuous reception operation the UE, where the message includes a request for information indicative of a location of the UE within a cell associated with the network entity. The communications manager 1120 is capable of, configured to, or operable to support a means for obtaining, within the active duration, a response message from the UE based on transmitting the message, where the response message indicates the information associated with the location of the UE within the cell. The communications manager 1120 is capable of, configured to, or operable to support a means for adjusting one or more communication parameters associated with the cell based on receiving the response message from the UE.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability, among other benefits. For example, by including or configuring the communications manager 1120 in accordance with examples as described herein, the device 1105 may receive responses from one or more UEs that may be used by the device 1105 to determine a location of the respective UEs (e.g., a geographic location, an area, a region, a cell, or the like), which may ensure that the device 1105 is able to maintain service to the respective UEs (e.g., while the device 1105 and/or the UEs are in a power-saving mode), thereby maintaining communications continuity and efficiency while simultaneously reducing or minimizing power consumption (e.g., for both the device 1105 and the UEs).

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of network energy savings techniques in the presence of camped user equipment as described herein, or the at least one processor 1135 and the at least one memory 1125 may be otherwise configured to, individually or collectively, perform or support such operations.

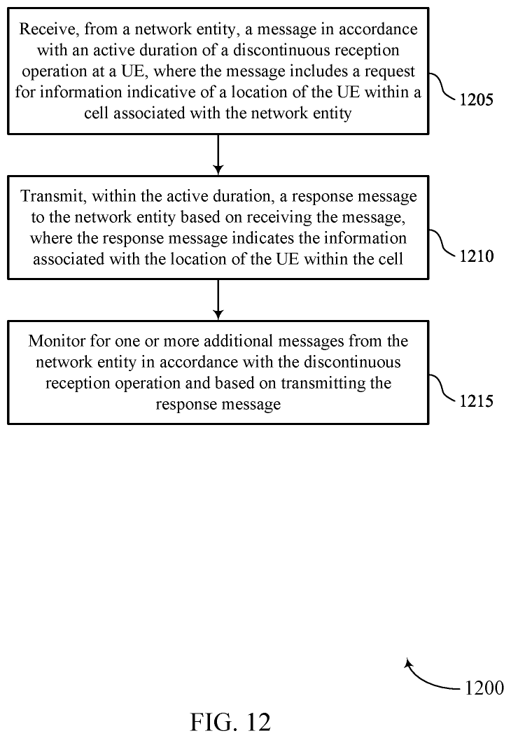

FIG. 12 shows a flowchart illustrating a method 1200 that supports network energy savings techniques in the presence of camped user equipment in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, a message in accordance with an active duration of a discontinuous reception operation at a UE, where the message includes a request for information indicative of a location of the UE within a cell associated with the network entity. The operations of 1205 may be performed in accordance with examples as disclosed herein. In some examples, aspects of the operations of 1205 may be performed by a request receiver component 625 as described with reference to FIG. 6.

At 1210, the method may include transmitting, within the active duration, a response message to the network entity based on receiving the message, where the response message indicates the information associated with the location of the UE within the cell. The operations of 1210 may be performed in accordance with examples as disclosed herein. In some examples, aspects of the operations of 1210 may be performed by a response transmitter component 630 as described with reference to FIG. 6.

At 1215, the method may include monitoring for one or more additional messages from the network entity in accordance with the discontinuous reception operation and based on transmitting the response message. The operations of 1215 may be performed in accordance with examples as disclosed herein. In some examples, aspects of the operations of 1215 may be performed by a monitoring component 635 as described with reference to FIG. 6.

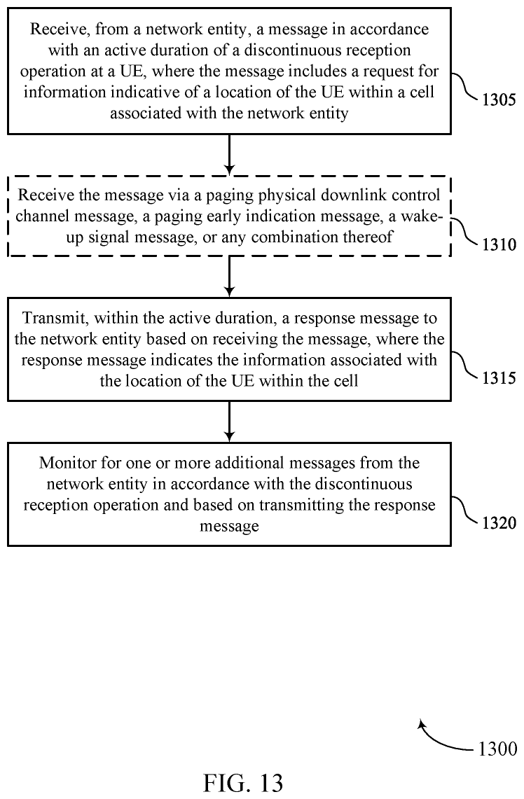

FIG. 13 shows a flowchart illustrating a method 1300 that supports network energy savings techniques in the presence of camped user equipment in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, a message in accordance with an active duration of a discontinuous reception operation at a UE, where the message includes a request for information indicative of a location of the UE within a cell associated with the network entity. The operations of 1305 may be performed in accordance with examples as disclosed herein. In some examples, aspects of the operations of 1305 may be performed by a request receiver component 625 as described with reference to FIG. 6.

At 1310, in some examples, the method may include receiving the message via a paging PDCCH message, a paging early indication message, a wake-up signal message, or any combination thereof. The operations of 1310 may be performed in accordance with examples as disclosed herein. In some examples, aspects of the operations of 1310 may be performed by a request receiver component 625 as described with reference to FIG. 6.

At 1315, the method may include transmitting, within the active duration, a response message to the network entity based on receiving the message, where the response message indicates the information associated with the location of the UE within the cell. The operations of 1315 may be performed in accordance with examples as disclosed herein. In some examples, aspects of the operations of 1315 may be performed by a response transmitter component 630 as described with reference to FIG. 6.

At 1320, the method may include monitoring for one or more additional messages from the network entity in accordance with the discontinuous reception operation and based on transmitting the response message. The operations of 1320 may be performed in accordance with examples as disclosed herein. In some examples, aspects of the operations of 1320 may be performed by a monitoring component 635 as described with reference to FIG. 6.

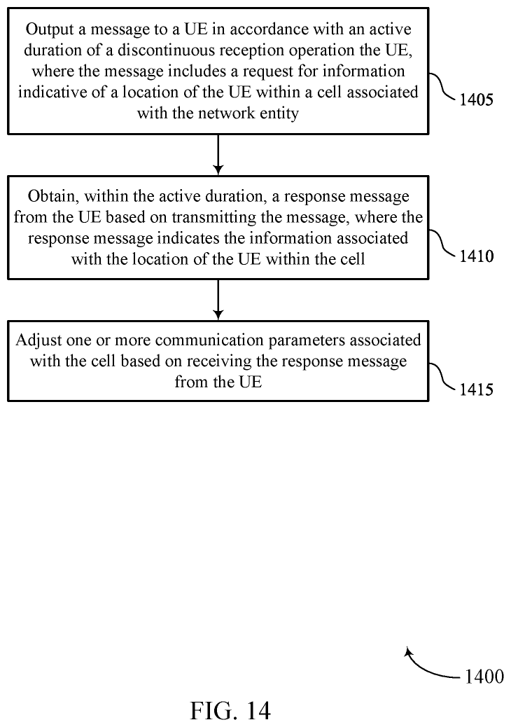

FIG. 14 shows a flowchart illustrating a method 1400 that supports network energy savings techniques in the presence of camped user equipment in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting a message to a UE in accordance with an active duration of a discontinuous reception operation the UE, where the message includes a request for information indicative of a location of the UE within a cell associated with the network entity. The operations of 1405 may be performed in accordance with examples as disclosed herein. In some examples, aspects of the operations of 1405 may be performed by a request transmitter component 1025 as described with reference to FIG. 10.

At 1410, the method may include obtaining, within the active duration, a response message from the UE based on transmitting the message, where the response message indicates the information associated with the location of the UE within the cell. The operations of 1410 may be performed in accordance with examples as disclosed herein. In some examples, aspects of the operations of 1410 may be performed by a response receiver component 1030 as described with reference to FIG. 10.

At 1415, the method may include adjusting one or more communication parameters associated with the cell based on receiving the response message from the UE. The operations of 1415 may be performed in accordance with examples as disclosed herein. In some examples, aspects of the operations of 1415 may be performed by a communication parameter component 1035 as described with reference to FIG. 10.

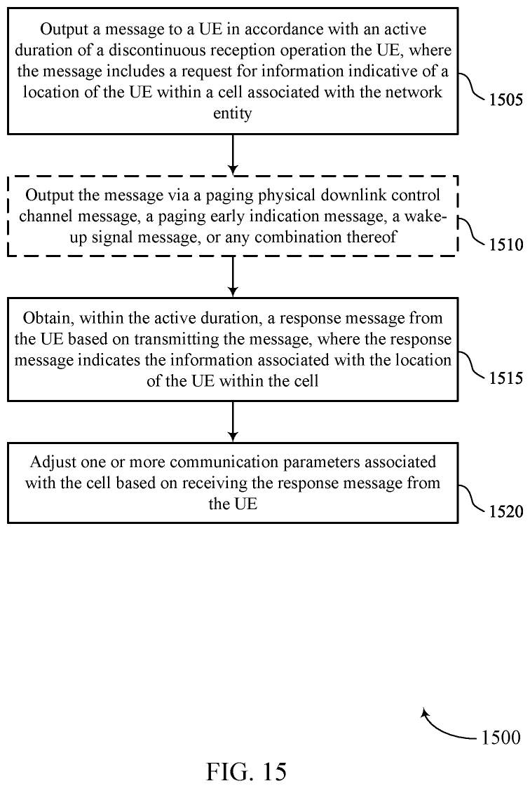

FIG. 15 shows a flowchart illustrating a method 1500 that supports network energy savings techniques in the presence of camped user equipment in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting a message to a UE in accordance with an active duration of a discontinuous reception operation the UE, where the message includes a request for information indicative of a location of the UE within a cell associated with the network entity. The operations of 1505 may be performed in accordance with examples as disclosed herein. In some examples, aspects of the operations of 1505 may be performed by a request transmitter component 1025 as described with reference to FIG. 10.

At 1510, in some examples, the method may include outputting the message via a paging PDCCH message, a paging early indication message, a wake-up signal message, or any combination thereof. The operations of 1510 may be performed in accordance with examples as disclosed herein. In some examples, aspects of the operations of 1510 may be performed by a request transmitter component 1025 as described with reference to FIG. 10.

At 1515, the method may include obtaining, within the active duration, a response message from the UE based on transmitting the message, where the response message indicates the information associated with the location of the UE within the cell. The operations of 1515 may be performed in accordance with examples as disclosed herein. In some examples, aspects of the operations of 1515 may be performed by a response receiver component 1030 as described with reference to FIG. 10.

At 1520, the method may include adjusting one or more communication parameters associated with the cell based on receiving the response message from the UE. The operations of 1520 may be performed in accordance with examples as disclosed herein. In some examples, aspects of the operations of 1520 may be performed by a communication parameter component 1035 as described with reference to FIG. 10.

The following provides an overview of aspects of the present disclosure:

Aspect 1: A method for wireless communications by a UE, comprising: receiving, from a network entity, a message in accordance with an active duration of a DRX operation at the UE, wherein the message comprises a request for information indicative of a location of the UE within a cell associated with the network entity; transmitting, within the active duration, a response message to the network entity based at least in part on receiving the message, wherein the response message indicates the information associated with the location of the UE within the cell; and monitoring for one or more additional messages from the network entity in accordance with the DRX operation and based at least in part on transmitting the response message.

Aspect 2: The method of aspect 1, wherein receiving the message comprises: receiving the message via a paging physical downlink control channel message, a paging early indication message, a wake-up signal message, or any combination thereof.

Aspect 3: The method of any of aspects 1 through 2, wherein receiving the message comprises: receiving the message in accordance with a directional parameter associated with the message, wherein the directional parameter is configured by the network entity.

Aspect 4: The method of any of aspects 1 through 3, wherein the request for the information is applicable to a set of UEs associated with the network entity, and transmitting the response message is based at least in part on the UE being included in the set of UEs.

Aspect 5: The method of aspect 4, wherein the set of UEs corresponds to a set of inactive UEs, a set of UEs associated with a same group identifier, a set of UEs associated with a same paging occasion, a set of UEs associated with a same paging frame, a set of UEs associated with a same UE type, a set of UEs associated with a same mobility state, a set of UEs associated with a same coverage region of the cell, or any combination thereof.

Aspect 6: The method of any of aspects 1 through 5, wherein transmitting the response message comprises: transmitting the response message via an uplink keep-alive signal message, an uplink wake-up signal message, or both.

Aspect 7: The method of any of aspects 1 through 6, wherein transmitting the response message comprises: transmitting the response message in accordance with a preamble identifier, a scrambling identifier, a resource configuration, or any combination thereof, wherein the information is indicative of the location of the UE based at least in part on the preamble identifier, the scrambling identifier, the resource configuration, or any combination thereof.

Aspect 8: The method of aspect 7, further comprising: selecting the preamble identifier, the scrambling identifier, the resource configuration, or any combination thereof based at least in part on an RSRP associated with the cell, a pathloss associated with the cell, a mobility state of the UE, a coverage region of the cell associated with the UE, a type associated with the UE, or any combination thereof, wherein transmitting the response message is based at least in part on the selecting.

Aspect 9: The method of any of aspects 1 through 8, further comprising: selecting a preamble identifier to use for transmitting the response message from a set of preamble identifiers configured by the network entity, wherein transmitting the response message is based at least in part on selecting the preamble identifier.

Aspect 10: The method of any of aspects 1 through 9, further comprising: receiving a capability message from the network entity that indicates whether the cell of the network entity supports communication of the message and the response message in accordance with the active duration of the DRX operation at the UE, wherein receiving the message is based at least in part on receiving the capability message.

Aspect 11: The method of any of aspects 1 through 10, further comprising: receiving a configuration message from the network entity that indicates one or more message parameters associated with receiving the message and one or more response parameters associated with transmitting the response message, wherein receiving the message or transmitting the response message, or both, are based at least in part on the configuration message.

Aspect 12: The method of any of aspects 1 through 11, further comprising: receiving a capability message associated with the message and the response message, a configuration message associated with the message and the response message, or both via a system information block message, a radio resource control message, a broadcast message, or any combination thereof.

Aspect 13: The method of any of aspects 1 through 12, further comprising: transmitting a second message to the network entity, the second message comprising second information associated with an area of the cell that is within a distance threshold of the UE.

Aspect 14: The method of aspect 13, further comprising: establishing a connection with the network entity based at least in part on receiving the message; and transmitting the response message, the second message, or both to the network entity based at least in part on establishing the connection.

Aspect 15: A method for wireless communications by a network entity, comprising: outputting a message to a UE in accordance with an active duration of a DRX operation the UE, wherein the message comprises a request for information indicative of a location of the UE within a cell associated with the network entity; obtaining, within the active duration, a response message from the UE based at least in part on transmitting the message, wherein the response message indicates the information associated with the location of the UE within the cell; and adjusting one or more communication parameters associated with the cell based at least in part on receiving the response message from the UE.

Aspect 16: The method of aspect 15, wherein adjusting the one or more communication parameters comprises: adjusting one or more of a quantity of discovery signals transmitted within a time duration and associated with one or more communication directions, a transmit power parameter of the network entity, a directional communication parameter, a quantity of random access channel resources associated with one or more communication directions, or any combination thereof.

Aspect 17: The method of any of aspects 15 through 16, wherein outputting the message comprises: outputting the message via a paging physical downlink control channel message, a paging early indication message, a wake-up signal message, or any combination thereof.

Aspect 18: The method of any of aspects 15 through 17, wherein outputting the message comprises: outputting the message in accordance with a directional parameter associated with the message, wherein the message is output in one or more directions from the network entity based at least in part on the directional parameter.

Aspect 19: The method of any of aspects 15 through 18, wherein the request for the information is applicable to a set of UEs associated with the network entity, and obtaining the response message is based at least in part on the UE being included in the set of UEs.

Aspect 20: The method of aspect 19, wherein the set of UEs corresponds to a set of inactive UEs, a set of UEs associated with a same group identifier, a set of UEs associated with a same paging occasion, a set of UEs associated with a same paging frame, a set of UEs associated with a same UE type, a set of UEs associated with a same mobility state, a set of UEs associated with a same coverage region of the cell, or any combination thereof.

Aspect 21: The method of any of aspects 15 through 20, wherein obtaining the response message comprises: obtaining the response message via an uplink keep-alive signal message, an uplink wake-up signal message, or both.

Aspect 22: The method of any of aspects 15 through 21, wherein obtaining the response message comprises: obtaining the response message in accordance with a preamble identifier, a scrambling identifier, a resource configuration, or any combination thereof, wherein the information is indicative of the location of the UE based at least in part on the preamble identifier, the scrambling identifier, the resource configuration, or any combination thereof.

Aspect 23: The method of aspect 22, further comprising: outputting an indication of the preamble identifier, the scrambling identifier, the resource configuration, or any combination thereof based at least in part on an RSRP associated with the cell, a pathloss associated with the cell, a mobility state of the UE, a coverage region of the cell associated with the UE, a type associated with the UE, or any combination thereof, wherein obtaining the response message is based at least in part on outputting the indication.

Aspect 24: The method of any of aspects 15 through 23, further comprising: configuring a set of preamble identifiers to use for obtaining one or more response messages, wherein obtaining the response message is based at least in part on configuring the set of preamble identifiers.

Aspect 25: The method of any of aspects 15 through 24, further comprising: outputting a capability message to the UE that indicates whether the cell of the network entity supports communication of the message and the response message in accordance with the active duration of the DRX operation at the UE, wherein outputting the message is based at least in part on outputting the capability message.

Aspect 26: The method of any of aspects 15 through 25, further comprising: outputting a configuration message to the UE that indicates one or more message parameters associated with outputting the message and one or more response parameters associated with obtaining the response message.

Aspect 27: The method of any of aspects 15 through 26, further comprising: outputting a capability message associated with the message and the response message, a configuration message associated with the message and the response message, or both via a system information block message, a radio resource control message, a broadcast message, or any combination thereof.

Aspect 28: The method of any of aspects 15 through 27, further comprising: obtaining, based at least in part on outputting the message, a second message, the second message comprising second information associated with an area of the cell that is within a distance threshold of the UE.

Aspect 29: The method of aspect 28, further comprising: establishing a connection with the UE based at least in part on outputting the message; and obtaining the response message, the second message, or both from the UE based at least in part on establishing the connection.

Aspect 30: A UE for wireless communications, comprising one or more memories storing processor-executable code, and one or more processors coupled with the one or more memories and individually or collectively operable to execute the code to cause the UE to perform a method of any of aspects 1 through 14.

Aspect 31: A UE for wireless communications, comprising at least one means for performing a method of any of aspects 1 through 14.

Aspect 32: A non-transitory computer-readable medium storing code for wireless communications, the code comprising instructions executable by one or more processors to perform a method of any of aspects 1 through 14.

Aspect 33: A network entity for wireless communications, comprising one or more memories storing processor-executable code, and one or more processors coupled with the one or more memories and individually or collectively operable to execute the code to cause the network entity to perform a method of any of aspects 15 through 29.

Aspect 34: A network entity for wireless communications, comprising at least one means for performing a method of any of aspects 15 through 29.

Aspect 35: A non-transitory computer-readable medium storing code for wireless communications, the code comprising instructions executable by one or more processors to perform a method of any of aspects 15 through 29.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, a message in accordance with an active duration of a discontinuous reception operation at the UE, wherein the message comprises a request for information indicative of a location of the UE within a cell associated with the network entity;
transmit, within the active duration, a response message to the network entity based at least in part on receiving the message, wherein the response message indicates the information associated with the location of the UE within the cell; and
monitor for one or more additional messages from the network entity in accordance with the discontinuous reception operation and based at least in part on transmitting the response message.

2. The UE of claim 1, wherein, to receive the message, the one or more processors are individually or collectively operable to execute the code to cause the UE to:
receive the message via a paging physical downlink control channel message, a paging early indication message, a wake-up signal message, or any combination thereof.

3. The UE of claim 1, wherein, to receive the message, the one or more processors are individually or collectively operable to execute the code to cause the UE to:
receive the message in accordance with a directional parameter associated with the message, wherein the directional parameter is configured by the network entity.

4. The UE of claim 1, wherein:
the request for the information is applicable to a set of UEs associated with the network entity; and
transmitting the response message is based at least in part on the UE being included in the set of UEs.

5. The UE of claim 4, wherein the set of UEs corresponds to a set of inactive UEs, a set of UEs associated with a same group identifier, a set of UEs associated with a same paging occasion, a set of UEs associated with a same paging frame, a set of UEs associated with a same UE type, a set of UEs associated with a same mobility state, a set of UEs associated with a same coverage region of the cell, or any combination thereof.

6. The UE of claim 1, wherein, to transmit the response message, the one or more processors are individually or collectively operable to execute the code to cause the UE to:
transmit the response message via an uplink keep-alive signal message, an uplink wake-up signal message, or both.

7. The UE of claim 1, wherein, to transmit the response message, the one or more processors are individually or collectively operable to execute the code to cause the UE to:
transmit the response message in accordance with a preamble identifier, a scrambling identifier, a resource configuration, or any combination thereof, wherein the information is indicative of the location of the UE based at least in part on the preamble identifier, the scrambling identifier, the resource configuration, or any combination thereof.

8. The UE of claim 7, wherein the one or more processors are individually or collectively further operable to execute the code to cause the UE to:
select the preamble identifier, the scrambling identifier, the resource configuration, or any combination thereof based at least in part on a reference signal receive power (RSRP) associated with the cell, a pathloss associated with the cell, a mobility state of the UE, a coverage region of the cell associated with the UE, a type associated with the UE, or any combination thereof, wherein transmitting the response message is based at least in part on the selecting.

9. The UE of claim 1, wherein the one or more processors are individually or collectively further operable to execute the code to cause the UE to:
select a preamble identifier to use for transmitting the response message from a set of preamble identifiers configured by the network entity, wherein transmitting the response message is based at least in part on selecting the preamble identifier.

10. The UE of claim 1, wherein the one or more processors are individually or collectively further operable to execute the code to cause the UE to:
receive a capability message from the network entity that indicates whether the cell of the network entity supports communication of the message and the response message in accordance with the active duration of the discontinuous reception operation at the UE, wherein receiving the message is based at least in part on receiving the capability message.

11. The UE of claim 1, wherein the one or more processors are individually or collectively further operable to execute the code to cause the UE to:
receive a configuration message from the network entity that indicates one or more message parameters associated with receiving the message and one or more response parameters associated with transmitting the response message, wherein receiving the message or transmitting the response message, or both, are based at least in part on the configuration message.

12. The UE of claim 1, wherein the one or more processors are individually or collectively further operable to execute the code to cause the UE to:
receive a capability message associated with the message and the response message, a configuration message associated with the message and the response message, or both via a system information block message, a radio resource control message, a broadcast message, or any combination thereof.

13. The UE of claim 1, wherein the one or more processors are individually or collectively further operable to execute the code to cause the UE to:
transmit a second message to the network entity, the second message comprising second information associated with an area of the cell that is within a distance threshold of the UE.

14. The UE of claim 13, wherein the one or more processors are individually or collectively further operable to execute the code to cause the UE to:
establish a connection with the network entity based at least in part on receiving the message; and
transmit the response message, the second message, or both to the network entity based at least in part on establishing the connection.

15. A network entity, comprising:
one or more memories storing processor-executable code; and
one or more processors coupled with the one or more memories and individually or collectively operable to execute the code to cause the network entity to:
output a message to a user equipment (UE) in accordance with an active duration of a discontinuous reception operation the UE, wherein the message comprises a request for information indicative of a location of the UE within a cell associated with the network entity;
obtain, within the active duration, a response message from the UE based at least in part on transmitting the message, wherein the response message indicates the information associated with the location of the UE within the cell; and
adjust one or more communication parameters associated with the cell based at least in part on receiving the response message from the UE.

16. The network entity of claim 15, wherein, to adjust the one or more communication parameters, the one or more processors are individually or collectively operable to execute the code to cause the network entity to:
adjust one or more of a quantity of discovery signals transmitted within a time duration and associated with one or more communication directions, a transmit power parameter of the network entity, a directional communication parameter, a quantity of random access channel resources associated with one or more communication directions, or any combination thereof.

17. The network entity of claim 15, wherein, to output the message, the one or more processors are individually or collectively operable to execute the code to cause the network entity to:
output the message via a paging physical downlink control channel message, a paging early indication message, a wake-up signal message, or any combination thereof.

18. The network entity of claim 15, wherein, to output the message, the one or more processors are individually or collectively operable to execute the code to cause the network entity to:
output the message in accordance with a directional parameter associated with the message, wherein the message is output in one or more directions from the network entity based at least in part on the directional parameter.

19. A method for wireless communications by a user equipment (UE), comprising:
receiving, from a network entity, a message in accordance with an active duration of a discontinuous reception operation at the UE, wherein the message comprises a request for information indicative of a location of the UE within a cell associated with the network entity;
transmitting, within the active duration, a response message to the network entity based at least in part on receiving the message, wherein the response message indicates the information associated with the location of the UE within the cell; and
monitoring for one or more additional messages from the network entity in accordance with the discontinuous reception operation and based at least in part on transmitting the response message.

20. The method of claim 19, wherein receiving the message comprises:
receiving the message via a paging physical downlink control channel message, a paging early indication message, a wake-up signal message, or any combination thereof.
